(19) United States
(12) Patent Application Publication
(10) Pub. No.: US 2026/0317216 A1
(43) Pub. Date: Oct. 15, 2026

(54) CIRCULATION PUMP FOR AERATING AND CIRCULATING WATER IN A FACULTATIVE LAGOON

(71) Applicants: Jerry Kellgren, Navarre, FL (US); John Kellgren, Navarre, FL (US)

(72) Inventors: Jerry Kellgren, Navarre, FL (US); John Kellgren, Navarre, FL (US)

(21) Appl. No.: 19/641,146

(22) Filed: Apr. 7, 2026

Related U.S. Application Data
(60) Provisional application No. 63/786,405, filed on Apr. 10, 2025.

(51) Int. Cl. C02F 3/12; B01F 23/231; B01F 23/237; B01F 23/2373; B01F 25/60; B01F 101/00; C02F 3/20; F04B 19/04; F04B 43/02; F04B 53/16

(52) U.S. Cl. CPC C02F 3/1284; B01F 23/231231; B01F 23/2373; B01F 23/237611; B01F 25/60; C02F 3/201; F04B 19/04; F04B 43/02; F04B 53/16; B01F 2101/305

(57) ABSTRACT

A pump for aerating and circulating water in a facultative lagoon includes a cylindrical pump housing with a housing wall, a concentrically aligned pump cylinder having an outer surface, inner surface, pump cavity, an upper cover with a center opening, and lower openings through the pump cylinder's lower portion. A bubble tube aligns concentrically inside the pump cylinder with the upper cover's center opening, the bubble tube being shorter than the pump cylinder. The pump includes a diffuser coil extending spirally adjacent the pump cylinder's outer surface, a first air inlet connected to the diffuser coil, a second air inlet with an air conduit terminating in the pump cavity, a concrete cavity below the pump cylinder, and vertical slots along the cylindrical pump housing's upper perimeter.

### CROSS-REFERENCE TO RELATED APPLICATIONS

This application claims the benefit of United States Provisional Patent Application No. 63/786,405, filed on Apr. 10, 2025, which is incorporated by reference herein in its entirety.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention, and the applicants, make no claim to any trademarks referenced.

### BACKGROUND OF THE INVENTION

### 1) Field of the Invention

The invention relates in general to the field of circulation pumps for aerating and circulating water in facultative lagoons used for wastewater treatment, and more particularly to a pneumatically operated pump that generates large bubbles to lift water from lower depths to the surface while simultaneously aerating the water through a diffuser coil to increase dissolved oxygen levels throughout the lagoon.

### 2) Description of Related Art

Currently the state of the art includes circulation pumps, fountains and air bubbles which are deployed to aerate a body of water.

There are a number of different lagoons, ponds and lakes which are used to provide various water retention functions and are usually permanent basins designed to manage stormwater runoff, reduce flooding, and improve water quality by capturing runoff from impervious surfaces like parking lots and roofs. One such water retention facility is facultative lagoons which are wastewater treatment systems that utilize both anaerobic and aerobic conditions to treat wastewater. These lagoons are commonly employed by small communities across the United States because they can cost less to operate and maintain than other treatment systems. Three distinct layers exist in a facultative lagoon: an aerobic zone at the top where aerobic bacteria use oxygen from air, algae through photosynthesis, and surface agitation from wind and rain to treat wastewater; a facultative zone in the middle containing bacteria that can function in both anaerobic and aerobic environments; and an anaerobic zone at the bottom containing no oxygen and housing a sludge layer where anaerobic bacteria, sludge worms, and microscopic organisms treat the wastewater. The aerobic zone also serves as a barrier for odor control.

Like all treatment systems, lagoons have operational and maintenance challenges that impact performance and regulatory compliance. Common problems with facultative lagoons include algae blooms, elevated effluent ammonia levels, elevated effluent biological oxygen demand (BOD), elevated effluent suspended solids, odors, water borne insects, and icing during cold weather periods.

Various methods exist to increase oxygen uptake in ponds and lagoons by artificially increasing the water's surface area through agitation or by spraying water into the air. While effective to some degree, these approaches have limitations in efficiency because surface waters used in the process are often already close to maximum oxygen saturation, and water droplets have limited surface area for gas exchange. These processes typically result in aerobic biological activity being restricted predominantly to surface waters in the upper portion of the water column, with oxygen concentrations decreasing rapidly with increasing depth.

Existing aeration techniques include waterfalls, venturi eductor nozzles, degassing towers, and air lift pumps. Waterfalls can provide aeration if designed with sufficient turbulence and splash points, but they are expensive to operate due to the power consumed by water pumps. Venturi eductor nozzles can add oxygen when positioned near the surface, but they create substantial back pressure on water pumps, resulting in higher electrical costs to compensate for loss in water flow. Degassing towers, also known as trickle towers, can aerate water effectively but require considerable height and involve substantial electrical costs to pump water to sufficient elevation.

Air lift pumps provide systems that utilize less power than other alternatives, but conventional designs may not achieve desired levels of dissolved oxygen. Fine bubble aeration systems are efficient at saturating vertical columns of water, but the fine bubbles created by diffusers absorb little or no oxygen at the water-atmosphere interface and result in limited horizontal circulation of the water. The greatest concentration of dissolved air is found around the diffuser itself, and these air lift pumps produce columns of aerated water that slowly diffuse throughout the water body via underwater currents caused by wind moving the surface water.

Alternative systems have been designed to take water from lower depths of a pond and pump it to the surface. These systems expose colder, low-oxygen water to air such that the difference in partial pressure is maximized and the amount of dissolved oxygen in the water is increased. However, the power consumed to operate the pumping systems of current technologies can be substantial, which may result in operators limiting the time the pumps are used.

These and other objects, features, and advantages of the present invention will become more readily apparent from the attached drawings and the detailed description of the preferred embodiments, which follow.

### SUMMARY OF THE INVENTION

Bearing in mind the problems and deficiencies of the prior art, it is therefore an object of the present invention to provide an improved pump for aerating and circulating water in a facultative lagoon or any other water retention lagoon or pond.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a pump for aerating and circulating water in a facultative lagoon is provided. The pump includes a cylindrical pump housing including a housing wall. The pump includes a pump cylinder aligned concentrically with the cylindrical pump housing. The pump cylinder includes an outer surface and an inner surface. The pump cylinder includes a pump cavity contained in the pump cylinder. The pump cylinder includes an upper cover having a center opening, the upper cover for preventing air from exiting the cavity at an upper cavity portion. The pump cylinder includes a plurality of lower openings extending through a lower portion of the pump cylinder. The pump includes a bubble tube aligned concentrically inside the pump cylinder whereby the center opening of the upper cover aligns with the bubble tube and wherein the bubble tube is shorter than the pump cylinder. The pump includes a diffuser coil extending spirally adjacent the outer surface of the pump cylinder. The pump includes a first air inlet for attachment to a first air supply the first air inlet connected to the diffuser coil. The pump includes a second air inlet for attachment to a second air supply. The pump includes an air conduit having a first end attached to the second air inlet and a second end terminating in the pump cylinder cavity. The pump includes a concrete cavity disposed below the pump cylinder, the concrete cavity for holding concrete. The pump includes a plurality of vertical slots extending along the upper perimeter of the cylindrical pump housing. The first air supply forces a first flow of air through the diffuser coil where it mixes with the water. The second air supply forces a second flow of water through the air conduit and into the pump cavity. Large bubbles are formed in the pump cavity until the forces of the water release each consecutive large bubble through a top opening of the bubble tube. The large bubbles force the water in an upward direction.

Still other objects and advantages of the invention will in part be obvious and will in part be apparent from the specification.

The above and other objects, which will be apparent to those skilled in the art, are achieved in the present invention which is directed to a pump for aerating and circulating water in a facultative lagoon, comprising:
a. a cylindrical pump housing including a housing wall;
b. a pump cylinder aligned concentrically with the cylindrical pump housing, the pump cylinder including an outer surface and an inner surface, a pump cavity contained in the pump cylinder, an upper cover having a center opening, and a plurality of lower openings extending through a lower portion of the pump cylinder;
c. a bubble tube aligned concentrically inside the pump cylinder whereby the center opening of the upper cover aligns with the bubble tube, wherein the bubble tube is shorter than the pump cylinder;
d. a diffuser coil extending spirally adjacent the outer surface of the pump cylinder;
e. a first air inlet for attachment to a first air supply, the first air inlet connected to the diffuser coil;
f. a second air inlet for attachment to a second air supply;
g. an air conduit having a first end attached to the second air inlet and a second end terminating in the pump cavity;
h. a concrete cavity disposed below the pump cylinder; and
i. a plurality of vertical slots extending along an upper perimeter of the cylindrical pump housing;
j. wherein the first air supply forces a first flow of air through the diffuser coil where the first flow of air mixes with water, wherein the second air supply forces a second flow of air through the air conduit and into the pump cavity, wherein large bubbles are formed in the pump cavity until forces of the water release each consecutive large bubble through a top opening of the bubble tube, and wherein the large bubbles force the water in an upward direction.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 depicts a cross-sectional diagram of a body of water without mechanical aeration, according to aspects of the present disclosure. (Prior art)

FIG. 2 depicts a cross-sectional diagram of a body of water with a small bubble aeration system, according to aspects of the present disclosure. (Prior art)

FIG. 3 depicts a cross-sectional view of a body of water with a small bubble aeration system, according to aspects of the present disclosure. (Prior art)

FIG. 4 depicts a cross-sectional view of a column of bubbles and aerated water formed by an operating diffuser, according to aspects of the present disclosure. (Prior art)

FIG. 5 illustrates an isometric plan view of a big bubble circulator, according to aspects of the present disclosure.

FIG. 6 illustrates a top plan view of the big bubble circulator of FIG. 5, according to aspects of the present disclosure.

FIG. 7 illustrates a cross-sectional view of the big bubble circulator of FIG. 5 without water, according to aspects of the present disclosure.

FIG. 8 illustrates a cross-sectional view of the big bubble circulator showing reference dimensions, according to aspects of the present disclosure.

FIG. 9 depicts a diagram showing a circulation pattern within a body of water for the big bubble circulator, according to aspects of the present disclosure.

FIG. 10 depicts forces acting on a super bubble released from the big bubble circulator, according to aspects of the present disclosure.

FIG. 11 illustrates a cross-sectional view of the big bubble circulator with water present, according to aspects of the present disclosure.

FIG. 12 depicts a cross-sectional view of a body of water incorporating a big bubble circulator into an aeration system, according to aspects of the present disclosure.

FIG. 13 illustrates a facultative lagoon diagram depicting layered structure and biological processes, according to aspects of the present disclosure.

FIG. 14 depicts a diagram showing a circulation pump providing water circulation in layers of a facultative lagoon, according to aspects of the present disclosure.

FIG. 15 illustrates a side elevational view of the circulation pump of FIG. 14 positioned in a facultative lagoon, according to aspects of the present disclosure.

FIG. 16 illustrates a top plan view of the circulation pump of FIG. 14, according to aspects of the present disclosure.

FIG. 17 illustrates a side elevational view of the circulation pump of FIG. 14 with a housing removed, according to aspects of the present disclosure.

FIG. 18 illustrates a cross-sectional view of the circulation pump of FIG. 14, according to aspects of the present disclosure.

FIG. 19 depicts a ripple pattern diagram showing a three-pump system configuration in a facultative lagoon, according to aspects of the present disclosure.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described.

The term water retention ponds (or wet ponds) as used in this disclosure are permanent basins designed to manage stormwater runoff, reduce flooding, and improve water quality by capturing runoff from impervious surfaces like parking lots and roofs

The term facultative lagoon or pond as used in this disclosure are a shallow, natural, or engineered wastewater treatment basin (1.2-2.4 m deep) that uses both aerobic and anaerobic processes to treat sewage.

Prior to a discussion of the preferred embodiment of the invention, it should be understood that while the features and advantages of the invention are illustrated in terms of a lagoon or pond there are many other water retention features which could benefit from the technology and the applicant reserves the rights to these applications in advance.

The following description sets forth exemplary aspects of the present disclosure. It should be recognized, however, that such description is not intended as a limitation on the scope of the present disclosure. Rather, the description also encompasses combinations and modifications to those exemplary aspects described herein.

operates by generating large bubbles that lift water from lower depths to the surface while simultaneously aerating water through a diffuser coil to increase dissolved oxygen levels. The circulation pump addresses challenges associated with maintaining water quality in bodies of water where oxygen depletion, thermal stratification, and organic material accumulation degrade aquatic environments. The circulation pump draws cold, oxygen-depleted bottom water to the surface where the water absorbs atmospheric oxygen across a wide area rather than at a localized bubble column. The circulation pump preserves natural thermal stratification while still circulating bottom water, unlike full lake destratification systems that collapse the thermocline.

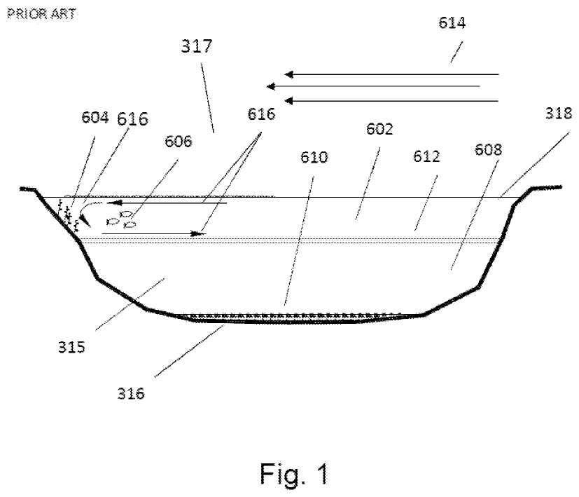

Referring to FIG. 1, a body of water 315 without mechanical aeration includes a surface of body of water 318 at the top and a bottom of body of water 316 at the lower boundary. Wind 614 moves across the surface of body of water 318 and creates circulation 616 within an upper layer of the body of water 315. The body of water 315 is divided into three distinct zones based on thermal stratification. An epilimnion 602 is the uppermost warm layer located near the surface of body of water 318. A thermocline 612 is positioned as a middle transitional layer between the epilimnion 602 and a lower zone. A hypolimnion 608 is the cold, dense bottom layer extending down to the bottom of body of water 316. Living plants 604 grow in the epilimnion 602 near the left side of the body of water 315. Fish 606 swim in the epilimnion 602, indicating that this oxygen-rich upper layer supports aquatic life. Atmospheric oxygen 317 enters the body of water 315 at the surface of body of water 318, where gas exchange occurs. Decaying organic material 610 accumulates at the bottom of body of water 316 within the hypolimnion 608, representing organic matter that has settled and is undergoing decomposition in the oxygen-depleted lower zone.

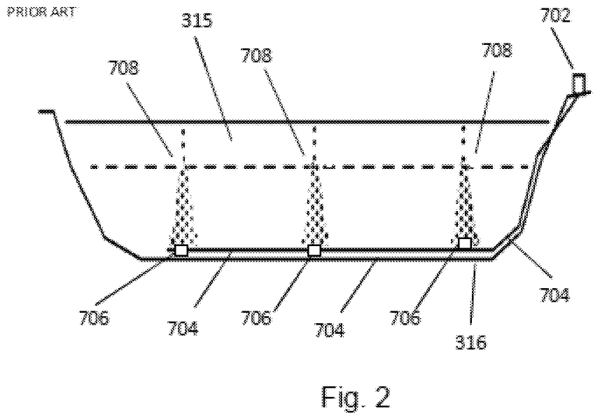

Referring to FIG. 2, a compressor station 702 is positioned at the surface level on the right side of the body of water 315. Multiple weighted air lines 704 extend from the compressor station 702 downward to the bottom of body of water 316. A plurality of fine bubble diffusers 706 are positioned along the bottom of body of water 316, with each fine bubble diffuser 706 connected to a respective weighted air line 704. Each fine bubble diffuser 706 generates a bubble column 708 that rises vertically from the bottom of body of water 316 toward the surface of the body of water 315.

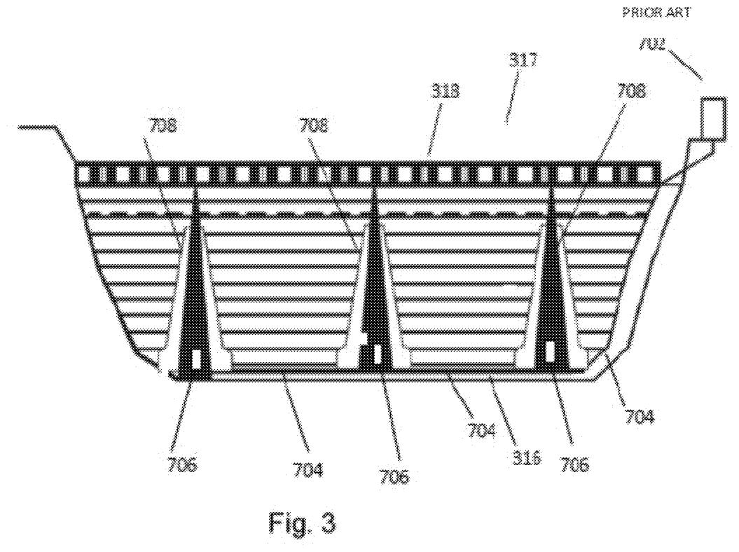

With continued reference to FIG. 3, the compressor station 702 supplies compressed air through weighted air lines 704 that extend downward to the bottom of body of water 316. Fine bubble diffusers 706 positioned at the bottom of body of water 316 receive air from the weighted air lines 704. The fine bubble diffusers 706 generate bubble columns 708 that rise upward through the water toward the surface of body of water 318. Atmospheric oxygen 317 is shown above the surface of body of water 318.

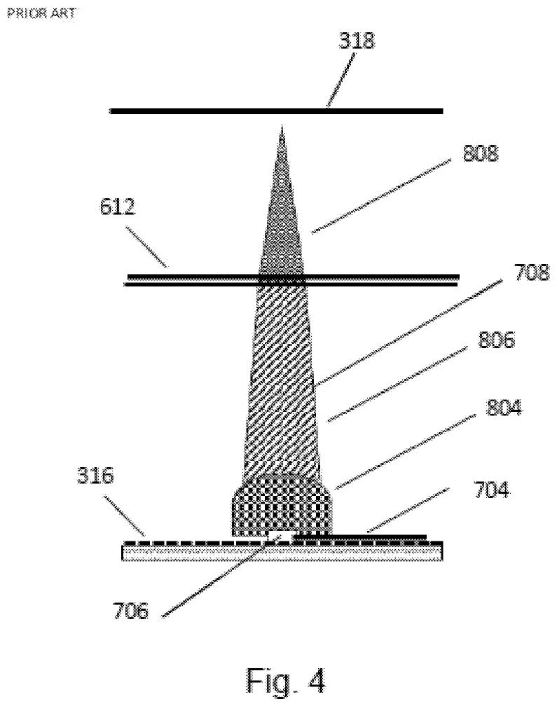

Referring to FIG. 4, the vertical structure of bubble formation and movement from the bottom of body of water 316 to the surface of body of water 318 is depicted, with the thermocline 612 positioned horizontally between these two boundaries. A weighted air line 704 connects to a fine bubble diffuser 706 positioned at the bottom of body of water 316. The fine bubble diffuser 706 generates bubbles that rise upward through the water column, forming a bubble column 708 that extends vertically toward the surface. The bubble column 708 is divided into three distinct zones based on bubble characteristics and behavior. A bubble zone 1 804 is located directly above the fine bubble diffuser 706 at the bottom of the water body. A bubble zone 2 806 is positioned above bubble zone 1 804 and below the thermocline 612. A bubble zone 3 808 extends from approximately the thermocline 612 level upward toward the surface of body of water 318.

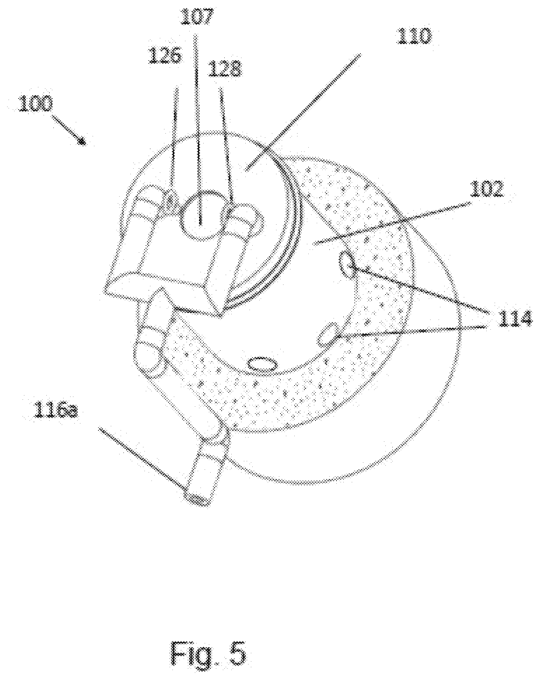

Referring to FIG. 5, a big bubble circulator 100 includes a first vertical tube 102 that forms the main cylindrical body of the device. An upper end plate 110 is positioned at the top of the first vertical tube 102 and includes a second vertical tube hole 107 located centrally within the upper end plate 110. A pair of eyebolts, including an eyebolt 126 and an eyebolt 128, are installed through the upper end plate 110 on opposite sides of the second vertical tube hole 107. The eyebolt 126 and eyebolt 128 are positioned approximately 180 degrees apart and serve as attachment points for lifting and lowering the big bubble circulator 100 into a body of water. A main air inlet 116a is connected to the upper portion of the big bubble circulator 100 and provides a connection point for compressed air to enter the device from a weighted air line. The first vertical tube 102 includes flood holes 114 positioned around its circumference at a lower portion of the tube.

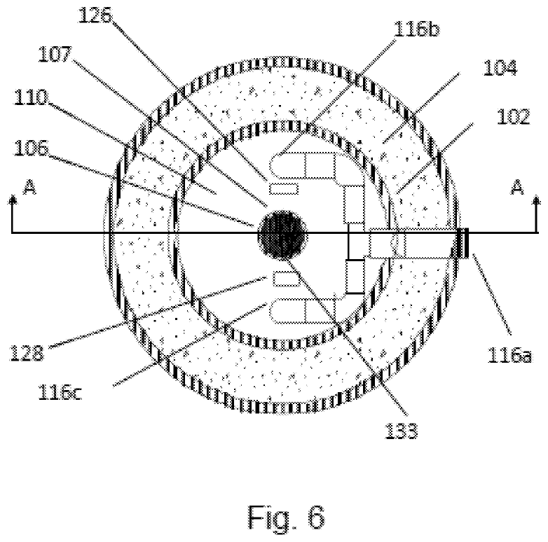

Referring to FIG. 6, the big bubble circulator 100 includes the first vertical tube 102 forming the outer cylindrical structure of the device. A second vertical tube 106 is positioned concentrically within the first vertical tube 102 and is visible through the second vertical tube hole 107 located at the center of the upper end plate 110. The main air inlet 116a is positioned on the exterior of the first vertical tube 102 and connects to an air inlet 116b and an air inlet 116c. The air inlet 116b and air inlet 116c are positioned approximately 180 degrees apart on the upper end plate 110, allowing compressed air to flow evenly into an expansion chamber to equalize pressure distribution. A ballast 104 is visible at the base of the first vertical tube 102, providing weight to overcome the buoyancy of the big bubble circulator 100 when submerged in water. A lower portion 133 of the device corresponds to the area where the first vertical tube 102 interfaces with the ballast 104.

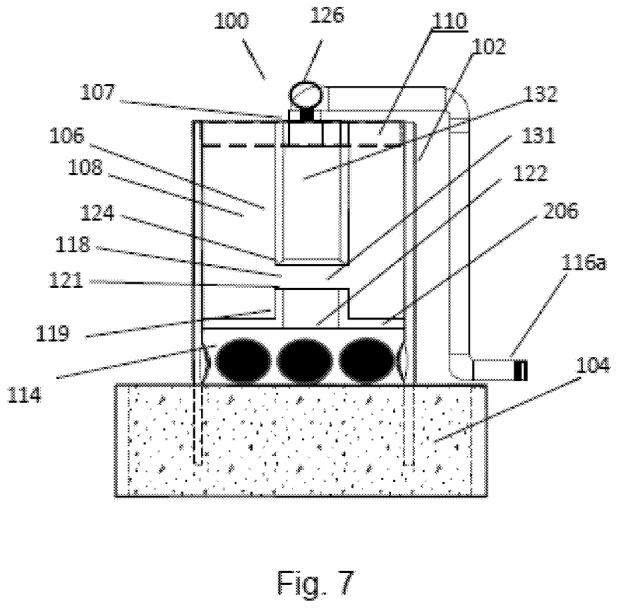

Referring to FIG. 7, a cross-sectional view through section A-A of the big bubble circulator 100 without water reveals the internal structure. The first vertical tube 102 forms the outer cylindrical structure of the device. The upper end plate 110 is positioned at the top of the first vertical tube 102 and includes the second vertical tube hole 107 at its center. The second vertical tube 106 extends downward from the upper end plate 110 into the interior of the first vertical tube 102, with the second vertical tube hole 107 aligned with the opening of the second vertical tube 106. The second vertical tube 106 defines a main chamber 132 within its interior. A third vertical tube 119 extends upward from a lower portion of the device and is positioned concentrically within the first vertical tube 102. The third vertical tube 119 includes a lower flat radial edge 121 at its upper terminus and a hole 122 that aligns with the second vertical tube hole 107. Between the second vertical tube 106 and the third vertical tube 119, a second chamber 131 is formed, with an opening 118 providing communication between an expansion chamber 108 and the second chamber 131. The second vertical tube 106 includes an upper sharp beveled radial edge 124 at its lower end, which forms the upper boundary of the opening 118. The expansion chamber 108 is defined in the annular space between the first vertical tube 102 and the second vertical tube 106. The flood holes 114 extend through the wall of the first vertical tube 102 at a lower portion to allow water to enter a flooded reservoir 206 located below the expansion chamber 108. The ballast 104 is positioned at the base of the first vertical tube 102 to provide stability and anchor the big bubble circulator 100 at the bottom of a body of water.

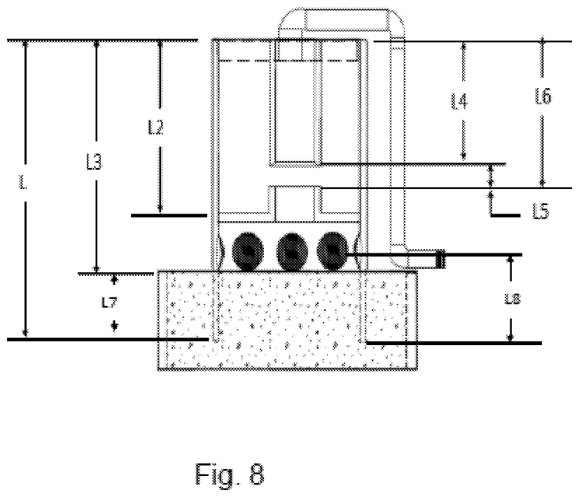

Referring to FIG. 8, a cross-sectional view through section A-A of the big bubble circulator without water shows reference dimensions. An expansion chamber height L2 represents the vertical distance from a lower endplate 112 to the upper end plate 110, which defines the height of the expansion chamber 108 where compressed air accumulates before forming bubbles. A tube length above ballast L3 indicates the minimum length of the first vertical tube 102 extending above the ballast 104, which is specified as three times the diameter of the first vertical tube 102. A second vertical tube length L4 represents the length of the second vertical tube 106 that extends into the first vertical tube cavity, with this dimension being between 40 to 90 percent of the distance between the lower endplate 112 and the upper end plate 110. An opening height L5 indicates the vertical position of the lower flat radial edge 121 that forms a lower boundary between the first vertical tube 102 and the second vertical tube 106, measured from the lower endplate 112. A second vertical tube interior length L6 represents the interior length of the second vertical tube 106, which equals 20 to 90 percent of the expansion chamber height L2. A ballast depth L7 indicates the portion of the first vertical tube 102 that is secured within the ballast 104, which is approximately one-sixth of the total length of the first vertical tube 102. A flood hole position L8 indicates the vertical position where the series of flood holes 114 are centered, which is approximately one-third of the distance from the vertical tube proximal end to the vertical tube distal end.

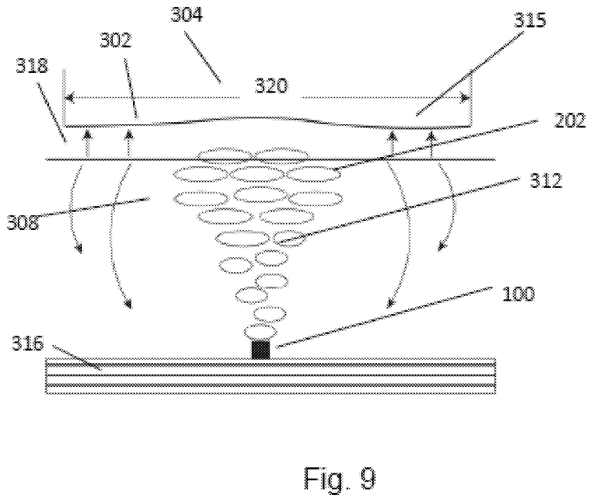

Referring to FIG. 9, the big bubble circulator 100 is positioned at the bottom of body of water 316 and generates super bubbles 202 that rise in a column toward the surface of body of water 318. An upper cover 304 is positioned at the surface of body of water 318 and spans a dimension 320 indicating the horizontal extent of the circulation effect. A mound of water 302 forms at the surface where the super bubbles 202 break through. Oxygenated water 308 flows outward from the mound of water 302 across the surface of body of water 318. A vertical circulation zone 312 is established within the body of water 315, depicted by curved arrows showing water movement downward along the outer edges and upward through the center where the super bubbles 202 rise.

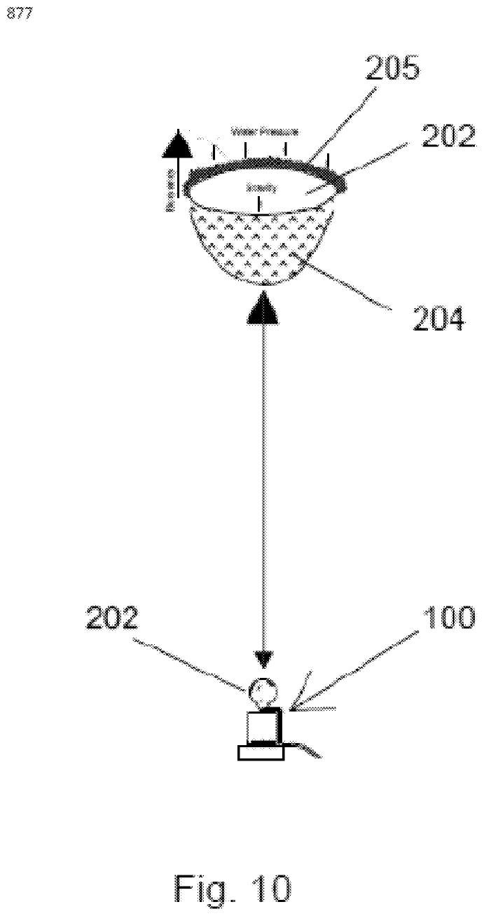

Referring to FIG. 10, the forces acting on a super bubble 202 released from the big bubble circulator 100 are depicted. Drafted water 204 extends from the big bubble circulator 100 toward the super bubble 202, indicating the water being pulled upward by the rising bubble. Water being lifted 205 is shown at the top of the super bubble 202, representing the water pressure acting on the upper surface of the super bubble 202. The super bubble 202 rises through the water column due to buoyancy, with the drafted water 204 following behind and the water being lifted 205 being carried along the upper surface of the super bubble 202.

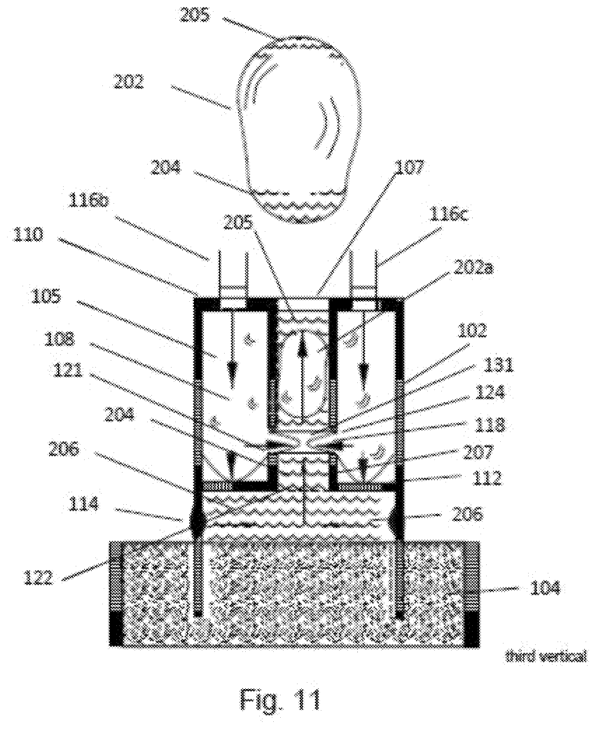

Referring to FIG. 11, a cross-sectional view through section A-A of the big bubble circulator with water present reveals the internal structure and operation of the device during water circulation. The air inlet 116b and air inlet 116c are positioned on the upper end plate 110 to allow compressed air to enter the device. The flood holes 114 are positioned in the lower portion of the first vertical tube 102 to allow water to enter the flooded reservoir 206 located between the ballast 104 and the lower endplate 112. The lower endplate 112 includes the hole 122 at its center. The expansion chamber 108 is formed between the lower endplate 112 and the upper end plate 110 within the first vertical tube 102. A first bubble 105 forms within the expansion chamber 108 as compressed air enters through the air inlet 116b and air inlet 116c. The opening 118 connects the expansion chamber 108 to the second chamber 131. The opening 118 is defined by the lower flat radial edge 121 and the upper sharp beveled radial edge 124. The upper sharp beveled radial edge 124 shears the compressed air mass as it moves through the opening 118 to form a second air bubble 202a within the second chamber 131. A third vertical tube cavity 207 is positioned below the second chamber 131 and connects to the flooded reservoir 206. The drafted water 204 is drawn upward from the flooded reservoir 206 through the third vertical tube cavity 207 and adheres to the bottom of the second air bubble 202a. The water being lifted 205 adheres to the top of the second air bubble 202a as it rises through the device. The second air bubble 202a exits through the second vertical tube hole 107 and forms the super bubble 202 above the device.

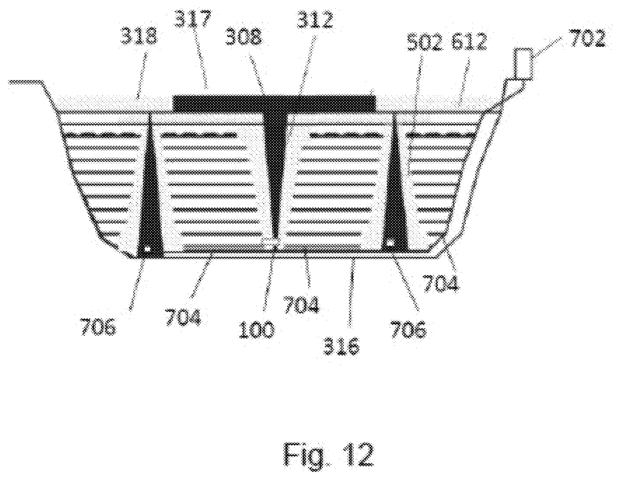

Referring to FIG. 12, the big bubble circulator 100 is incorporated within a new or existing small bubble aeration system to create the vertical circulation zone 312 between two fine bubble diffusers 706. The compressor station 702 supplies compressed air through weighted air lines 704 to the fine bubble diffusers 706 and big bubble circulator 100 located on the bottom of body of water 316. A diffuser 502 is positioned adjacent to the big bubble circulator 100. The oxygenated water 308 flows across the surface of body of water 318 after being lifted by the big bubble circulator 100. The atmospheric oxygen 317 is absorbed by the water at the surface of body of water 318. The thermocline 612 layer is indicated within the body of water between the surface and bottom regions.

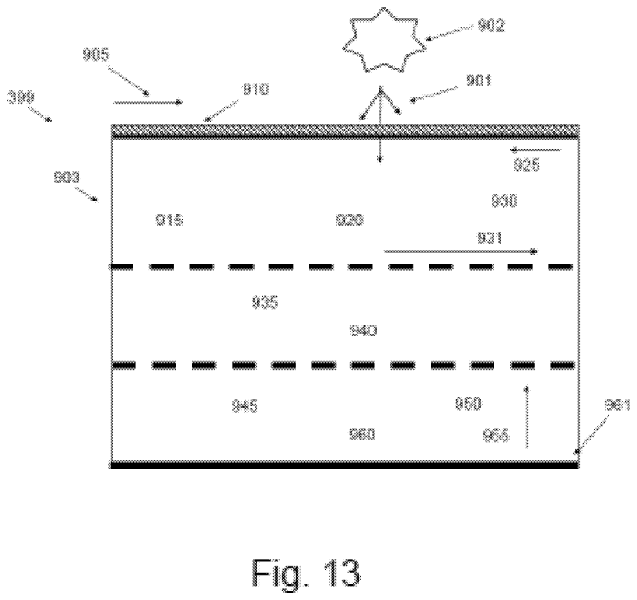

Referring to FIG. 13, a facultative lagoon diagram 399 depicts the layered structure and biological processes within a facultative lagoon used for wastewater treatment. The facultative lagoon diagram 399 shows three distinct zones arranged vertically within the water body including an aerobic zone at the top, a facultative zone in the middle, and an anaerobic zone at the bottom.

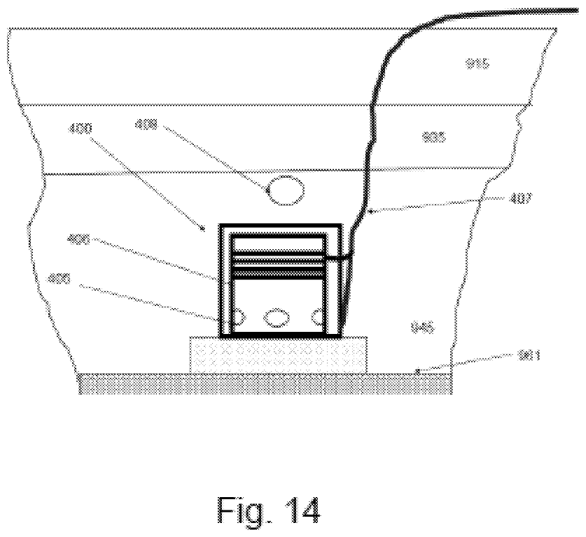

Referring to FIG. 14, a pump 400 provides water circulation in the layers of the facultative lagoon. The pump 400 is positioned within a facultative lagoon environment with an air supply line extending above the water surface to receive compressed air from an external source. The pump 400 is positioned within a mixing zone where water circulation occurs.

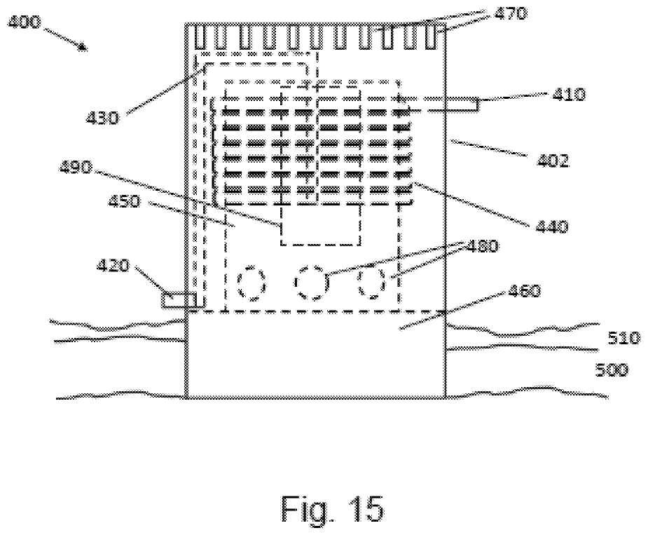

Referring to FIG. 15, a side elevational view of the pump 400 positioned in a facultative lagoon environment is depicted. The pump 400 includes a cylindrical pump housing 402 that provides the outer structural enclosure for the device. The cylindrical pump housing 402 features a plurality of vertical slots 470 extending along the upper perimeter, which allow water flow through the housing. Within the cylindrical pump housing 402, a pump cylinder 450 is aligned concentrically. The pump cylinder 450 contains a bubble tube 490 positioned concentrically inside. A diffuser coil 440 extends spirally adjacent to the outer surface of the pump cylinder 450. The pump 400 includes a first air inlet 410 for attachment to a first air supply, with the first air inlet 410 connected to the diffuser coil 440. A second air inlet 420 is provided for attachment to a second air supply. An air conduit 430 has a first end attached to the second air inlet 420 and extends downward into the pump structure. The pump cylinder 450 includes a plurality of lower openings 480 extending through a lower portion of the pump cylinder 450, which allow water to enter the pump cavity. A concrete cavity 460 is disposed below the pump cylinder 450 and serves to hold concrete that provides ballast to stabilize the pump 400 in position. The pump 400 is shown positioned within the lagoon environment, with a sludge layer 500 at the bottom and a light sludge layer 510 above the sludge layer 500.

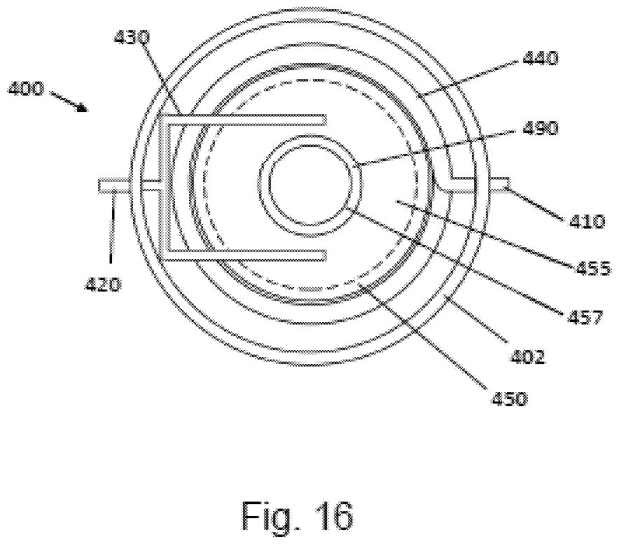

Referring to FIG. 16, a top plan view of the pump 400 is depicted. The pump cylinder 450 features an upper cover 455 having a center opening 457, where the upper cover 455 functions to prevent air from exiting the cavity at an upper cavity portion. The bubble tube 490 is aligned concentrically inside the pump cylinder 450, with the center opening 457 of the upper cover 455 aligning with the bubble tube 490. The diffuser coil 440 extends spirally adjacent the outer surface of the pump cylinder 450, positioned within the annular space between the pump cylinder 450 and the cylindrical pump housing 402.

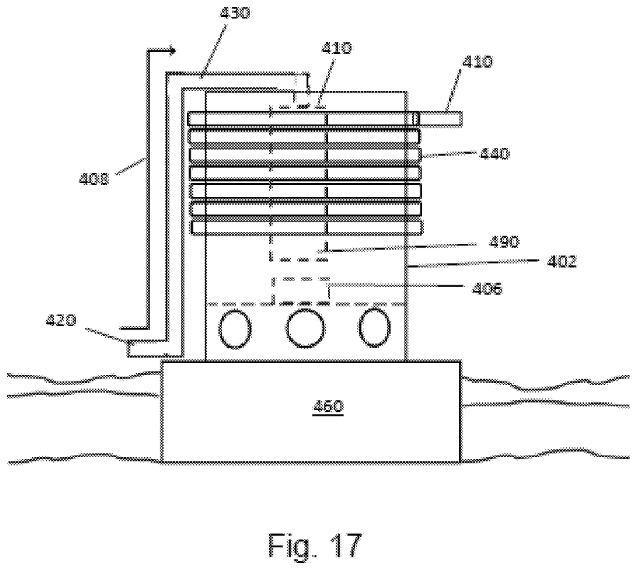

Referring to FIG. 17, a side elevational view of the pump 400 with the housing removed reveals the internal components and their arrangement. The diffuser coil 440 comprises multiple horizontal coil sections arranged vertically within the pump structure. A short bottom tube 406 is positioned axially below the bubble tube 490 to facilitate the formation of larger bubbles. A second flow 408 is indicated by an arrow showing the direction of air movement through the air conduit 430 into the pump cavity. The concrete cavity 460 is disposed at the lower portion of the pump below the diffuser coil 440.

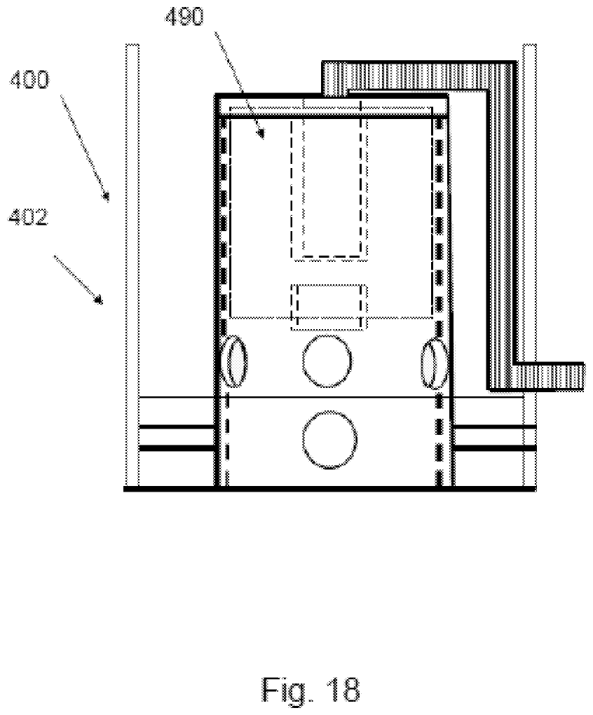

Referring to FIG. 18, a cross-sectional view of the pump 400 reveals the internal arrangement and structure of the pump 400. The cylindrical pump housing 402 forms the outer enclosure of the pump 400, providing structural support and defining the overall shape of the device. The bubble tube 490 is positioned concentrically within the interior of the pump 400 and extends vertically through the central portion of the assembly.

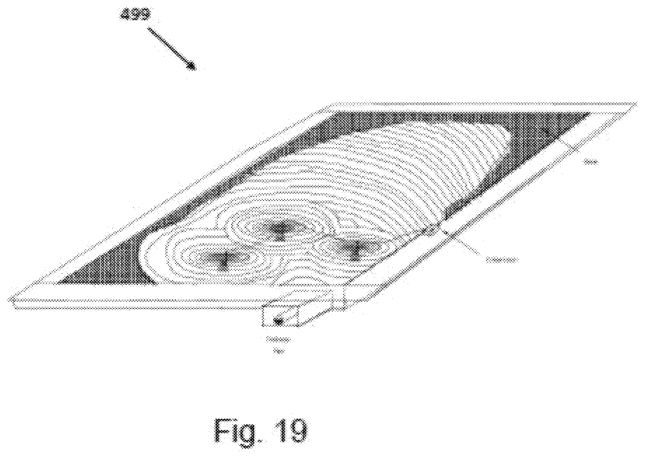

Referring to FIG. 19, a ripple pattern diagram 499 shows a three-pump system configuration in a facultative lagoon. The ripple pattern diagram 499 illustrates a rectangular lagoon with three circulation pumps positioned within the lagoon, each generating concentric ripple patterns that radiate outward across the water surface. The ripple patterns from the three pumps overlap and interact, creating a combined wave field that covers the entire lagoon surface.

The circulation pump technology is applicable to private pond and lake aeration and circulation, dock and marina water clearing for algae, debris, and floating vegetation, golf course pond management, HOA and community pond maintenance, winter dock and piling de-icing and ice prevention, and resort and recreational property water quality. The circulation pump serves as a piggyback enhancer for existing bottom-diffuser aeration systems by adding horizontal surface circulation to systems that provide vertical mixing. The circulation pump is suitable for shallow water body aeration where in-water electricity is a safety concern. The circulation pump provides storm turnover prevention in stratified lakes.

The circulation pump provides evaporation reduction and surface temperature management through a continuous ripple field that scatters and reflects incoming solar radiation, reducing heat absorption at the water surface, lowering surface water temperature, and reducing evaporation rate. The circulation pump provides solar radiation management for algae prevention through a ripple field that diffuses photosynthetically active radiation entering the water column, reducing the light availability that drives algae and cyanobacterial growth. The circulation pump provides fish kill prevention by maintaining dissolved oxygen levels through continuous bottom-to-surface circulation, preventing seasonal fish kills caused by oxygen depletion during summer stratification, winter ice cover, or storm-induced turnover events.

The circulation pump provides nutrient redistribution by transporting nutrients trapped in the oxygen-depleted bottom layer up to the epilimnion 602 where the nutrients are utilized by beneficial plants and aquatic life rather than accumulating as sediment. The circulation pump provides organic sediment and muck reduction by oxygenating bottom water to accelerate aerobic decomposition of organic material on the lakebed, reducing muck accumulation over time and improving water clarity and depth. The circulation pump is applicable to aquaculture and fish farming pond management, irrigation pond maintenance, livestock watering pond management, stormwater retention pond circulation, fire suppression pond maintenance, industrial cooling pond circulation, and reservoir water quality management.

The circulation pump provides multi-acre horizontal surface circulation from a single unit. The circulation pump draws cold, oxygen-depleted bottom water to the surface where the water absorbs atmospheric oxygen across a wide area. The circulation pump operates with zero in-water electricity, eliminating the risk of Electric Shock Drowning. The circulation pump preserves natural thermal stratification while still circulating bottom water. The circulation pump complements existing bottom-diffuser systems rather than replacing the bottom-diffuser systems, where diffusers handle vertical mixing and dissolved oxygen saturation while the circulation pump adds horizontal surface sweep.

The circulation pump generates a continuous ripple field that clears algae, debris, and floating vegetation from dock and marina areas. Winter operation of the circulation pump prevents ice formation around docks and pilings, protecting infrastructure. The circulation pump provides storm turnover prevention through persistent radial ripples that counteract wind-driven horizontal displacement of warm surface water that collapses stratification. The circulation pump operates with near-zero maintenance due to the absence of motor seals, impellers, clogging, and underwater electrical connections to inspect. Under 10 feet of depth, the circulation pump is operated on a 210 W linear compressor at roughly $294 per year at $0.16 per kWh running continuously.

The circulation pump provides evaporation and surface heating reduction through a ripple field that scatters solar radiation across a wider surface area, reducing localized heat absorption and slowing evaporative loss. The circulation pump provides algae growth suppression via light management through surface ripples that scatter and diffuse sunlight penetration into the water column, reducing photosynthetically active radiation available to algae at depth. The circulation pump provides fish kill prevention through continuous circulation that maintains dissolved oxygen levels year-round, preventing the oxygen crashes that cause seasonal fish kills.

The circulation pump provides bottom nutrient mobilization by lifting nutrients from the anaerobic bottom layer into the productive upper water column where the nutrients support beneficial biological activity rather than fueling sediment accumulation. The circulation pump provides accelerated organic sediment decomposition through oxygenated bottom water that promotes aerobic breakdown of accumulated muck and organic material, improving water clarity and usable depth over time. The circulation pump provides wildlife and habitat safety through the absence of electrical fields, mechanical blades, and chemical inputs, making the circulation pump compatible with sensitive aquatic ecosystems.

The circulation pump provides recreational safety and compatibility through the absence of surface hazards, electrical risk to swimmers, and interference with boats or fishing. The circulation pump provides silent, low-profile operation through the absence of motor noise and visible surface equipment, maintaining the aesthetic quality of residential, resort, and golf course water features.

The big bubble circulator 100 is made of metals or rigid plastics resistant to degradation from salt or fresh water. The big bubble circulator 100 is scalable and is made in various sizes when the proportions remain constant. The diameter of the first vertical tube 102 is selected from dimensions from 3 to 48 inches, with a preferred diameter of 12 inches. The first vertical tube 102 has a minimum diameter of three times the diameter of the second vertical tube 106. The minimum length of the first vertical tube 102 above the ballast 104 is three times the diameter of the first vertical tube 102. The dimension of the second vertical tube hole 107 is from 1/10 to ⅓ the diameter of the first vertical tube 102.

The upper end plate 110 has a minimum thickness of one quarter the diameter of the second vertical tube 106. The lower endplate 112 has a minimum thickness of one eighth the diameter of the second vertical tube 106. The flood holes 114 are centered approximately ⅓ of the distance from the vertical tube proximal end to the vertical tube distal end and have a diameter approximately equal to ⅙ the distance from the vertical tube proximal end to the vertical tube distal end. The first vertical tube 102 is positioned into the ballast 104 such that approximately ⅙ of the length of the first vertical tube 102 is secured in the ballast 104.

The dimension of the opening 118 is ten to thirty percent of the distance between the lower endplate 112 and the upper end plate 110, with a preferred dimension of 15 percent. The length of the second vertical tube 106 is 40 to 90 percent of the distance between the lower endplate 112 and the upper end plate 110. The lower flat radial edge 121 of the opening of the third vertical tube 119 is from 0 to 45 degrees from perpendicular, with a preferred angle of 0 degrees. The upper sharp beveled radial edge 124 of the second vertical tube 106 is 30 to 85 degrees from perpendicular, with a preferred angle of 45 degrees, and the angled surface faces towards the main chamber 132.

The super bubble 202 is from 1 inch to 10 inches in diameter. The second vertical tube 106 is attached to the upper end plate 110 by welding, adhesive, or mechanical seals with the appropriate gasket. The bonding method for the upper end plate 110 is welding, adhesive, or other suitable mechanical means with the proper gasket. The ballast 104 is formed from suitable materials such as concrete, metal, or epoxy. The air inlet 116b and air inlet 116 c are positioned 180 degrees apart to allow compressed air to flow evenly into the expansion chamber 108 to equalize the pressure. Additional air inlets are incorporated into the design to ensure uniform air flow into the expansion chamber 108. The eyebolt 126 and eyebolt 128 are installed 180 degrees apart through the upper end plate 110 to lift and lower the big bubble circulator 100 into the body of water 315.

The pump 400 is manufactured from environmentally benign heavy-duty HDPE. The pump 400 weighs about 180 pounds and includes a sufficient amount of concrete to keep the pump 400 stabilized in the sludge of a facultative lagoon. An approximate minimum depth of water for operation is 30 inches. The first air inlet 410 feeds compressed air to the diffuser coil 440, which is similar to a soaker hose, forming micro-bubbles within the pump mixing zone. The second air inlet 420 creates hundreds of large bubbles that expand as the large bubbles rise to the surface, drafting and lifting water in an upward direction. The short bottom tube 406 is axially aligned under the bubble tube 490 to facilitate larger bubbles.

The big bubble circulator 100 produces approximately ten super bubbles 202 per second, equating to more than 300 gallons per minute of cold low oxygen water from the bottom of body of water 316 to the surface of body of water 318. The super bubbles 202 breaking at the surface create a stream of churning low oxygen cold water that flows across the body of water 315 up to 50 yards in all directions. A one-millimeter fine bubble rises at approximately 1 foot per minute, a five-inch super bubble rises at approximately 4 feet per minute, and a nine-inch super bubble rises at 9 feet per minute. A nine-inch super bubble lifts and drafts approximately two quarts of cold low oxygen water from the bottom of body of water 316 to the surface of body of water 318. The super bubble 202 starts out as a five-inch super bubble at the big bubble circulator 100 and is a nine-inch super bubble after rising 32 feet in water.

The flow of air from the compressor station 702 through the individual weighted air lines 704 to the fine bubble diffusers 706 is set at sixty percent of the flow recommended by the diffuser manufacturers. The remainder of the air available from the compressor station 702 is divided evenly to any big bubble circulators 100 in the system. Preferred pumps include rocking piston pumps on deeper lake or pond applications greater than 6 feet and a diaphragm pump for shallow applications.

When the large bubbles push water through the aerobic surface layer, a pulsating mound forms pushing water outwards in all directions across the surface layer. The ripples are about the size of those made by a 10-mph wind blowing across open water. The ripples create openings across the entire surface that allow movement of oxygen and other off gases between the water and the atmosphere. The pumps are located closer to the effluent weir to form a zone that is more thoroughly mixed than the ripples flowing out into the lagoon.

The pump 400 creates ripples over the entire lagoon that diffuse the light required by the algae for photosynthesis. The ripples from the pump 400 create a surface counterflow to the lagoon's natural flow which creates a more even plug flow through the entire lagoon. The pump 400 does not disturb the sludge layer 500 while water flows in from the upper aerobic zone. The submerged pump 400 keeps water areas that do not experience a long hard freeze from icing over.

Typical design criteria for facultative lagoons include detention of 20 to 180 days, depth 4 to 8 feet, organic loading 10 to 100 pounds of biological oxygen demand per acre per day, and temperature above 68 degrees Fahrenheit. The taller unit geometry of the pump 400 is optimized for deeper water columns typical of facultative lagoons at 4 to 8 feet depth. The pump 400 has vertical slots 470 along the upper housing perimeter versus round flood holes in the big bubble circulator 100. The pump 400 is designed for multi-pump system deployment with multiple pumps positioned to create overlapping ripple patterns that cover entire lagoon surfaces.

Under 10 feet of depth, the pump 400 is operated on a 210 W linear compressor at roughly $294 per year at $0.16 per kWh running continuously. The pump 400 creates a pulsating surface dome approximately 10 inches high and 2 feet in diameter displacing approximately 160 pounds of water per pulse. The pump 400 has a 20-year warranty on the unit due to HDPE construction with no moving parts.

The system features which are specific for facultative lagoons or ponds include:
a. Taller unit geometry optimized for deeper water columns typical of facultative lagoons (4-8 feet)
b. HDPE construction rated for wastewater environments—environmentally benign, heavy-duty
c. Integrated diffuser coil spiraling around the outer pump cylinder—provides fine-bubble aeration in addition to the large-bubble circulation
d. Dual air supply design—first air supply feeds the diffuser coil for dissolved oxygen, second air supply feeds the pump cavity for large-bubble generation; allows independent tuning of aeration vs. circulation
e. Vertical slots along the upper housing perimeter (vs. round flood holes in the original Big Bubble Circulation Pump (BBCP)—The vertical slots optimized water intake for the lagoon environment
f. Concrete ballast cavity integrated into the base
g. Designed for multi-pump system deployment—multiple BBFCPs positioned to create overlapping ripple patterns that cover entire lagoon surfaces (the 3-pump ripple pattern configuration as shown in FIG. 19).

Referring to FIG. 1, the body of water 315 without mechanical aeration exhibits thermal stratification that creates three distinct zones based on the physical properties of water. The epilimnion 602 forms the uppermost layer and contains less dense warm water that absorbs oxygen from the atmosphere as wind 614 moves across the surface of body of water 318. The wind 614 creates circulation 616 within the epilimnion 602 by moving surface water and generating currents that distribute oxygen throughout the upper layer. The thermocline 612 is positioned as a middle transitional layer between the epilimnion 602 and the hypolimnion 608, with the thermocline 612 varying in temperature and thickness throughout the year. The hypolimnion 608 forms the cold, dense bottom layer extending down to the bottom of body of water 316, with the hypolimnion 608 containing water that is virtually devoid of free oxygen.

With continued reference to FIG. 1, living plants 604 grow in the epilimnion 602 and use sunlight for photosynthesis to add oxygen to the upper layer. Fish 606 inhabit the epilimnion 602 where dissolved oxygen levels range from 3 to 6 parts per million, supporting aquatic life in the oxygen-rich upper zone. The atmospheric oxygen 317 enters the body of water 315 at the surface of body of water 318 through gas exchange that occurs when the wind 614 moves across the surface and creates gentle wave action. The living plants 604 and the fish 606 thrive in the epilimnion 602 due to the combination of oxygen from the atmospheric oxygen 317 and oxygen produced through photosynthesis.

As further shown in FIG. 1, decaying organic material 610 accumulates at the bottom of body of water 316 within the hypolimnion 608. The decaying organic material 610 originates from the living plants 604 and the fish 606 that die and settle to the bottom of body of water 316. The hypolimnion 608 contains less than 3 parts per million dissolved oxygen and does not support the fish 606. The decaying organic material 610 undergoes decomposition in the oxygen-depleted lower zone, consuming available oxygen and contributing to the anaerobic conditions in the hypolimnion 608. The thermal stratification prevents mixing between the epilimnion 602 and the hypolimnion 608, resulting in the decaying organic material 610 remaining at the bottom of body of water 316 where anaerobic bacteria break down the organic matter.

Referring to FIG. 2, the body of water 315 includes a small bubble aeration system installed to increase dissolved oxygen levels throughout the water column. The compressor station 702 is positioned at the surface level on the right side of the body of water 315 and supplies compressed air to equipment positioned at the bottom of body of water 316. Multiple weighted air lines 704 extend from the compressor station 702 downward through the body of water 315 to the bottom of body of water 316. Each weighted air line 704 connects the compressor station 702 to a respective fine bubble diffuser 706 positioned along the bottom of body of water 316.

With continued reference to FIG. 2, the plurality of fine bubble diffusers 706 are distributed along the bottom of body of water 316 to provide aeration coverage across the water body. Each fine bubble diffuser 706 receives compressed air from the compressor station 702 through the corresponding weighted air line 704. The fine bubble diffusers 706 are constructed from engineered plastics that create extremely small bubbles when compressed air is forced through the material. The fine bubble diffusers 706 emit bubbles that are less than 1 millimeter in diameter, with the small bubble size allowing the bubbles to dissolve into the surrounding water at rates of 90 to 100 percent.

As further shown in FIG. 2, each fine bubble diffuser 706 generates a bubble column 708 that rises vertically from the bottom of body of water 316 toward the surface of the body of water 315. The bubble columns 708 are represented by dotted conical patterns extending upward from each fine bubble diffuser 706, indicating the path of rising bubbles through the water column. A dashed horizontal line traverses the body of water 315 between the surface and the bottom of body of water 316, indicating a layer boundary within the water column that corresponds to thermal stratification. The bubble columns 708 aerate vertical columns of water as the bubbles rise, with the greatest concentration of dissolved air found around each fine bubble diffuser 706 where the bubbles initially form. The bubble columns 708 diffuse throughout the body of water 315 via underwater currents caused by wind moving the surface water, though this diffusion process occurs slowly without additional circulation mechanisms.

Referring to FIG. 3, a cross-sectional view of a body of water with a small bubble aeration system depicts the arrangement and operation of components that deliver dissolved oxygen throughout the water column. The compressor station 702 is positioned above the surface of body of water 318 and generates compressed air that is distributed to submerged aeration equipment. The compressor station 702 connects to multiple weighted air lines 704 that extend downward through the body of water to the bottom of body of water 316. Each weighted air line 704 delivers compressed air from the compressor station 702 to a corresponding fine bubble diffuser 706 positioned at the bottom of body of water 316.

With continued reference to FIG. 3, the fine bubble diffusers 706 are distributed along the bottom of body of water 316 to provide aeration coverage across the water body. Each fine bubble diffuser 706 receives compressed air through the respective weighted air line 704 and emits small bubbles that rise through the water column. The fine bubble diffusers 706 generate bubble columns 708 that extend vertically from the bottom of body of water 316 toward the surface of body of water 318. The bubble columns 708 represent the path of rising bubbles as the bubbles travel upward through the water, dissolving oxygen into the surrounding water during the ascent.

As further shown in FIG. 3, atmospheric oxygen 317 is present above the surface of body of water 318, providing an additional source of oxygen for the water body through gas exchange at the air-water interface. The bubble columns 708 rise toward the surface of body of water 318 where the atmospheric oxygen 317 contributes to oxygenation of surface waters. The flow of air from the compressor station 702 through the individual weighted air lines 704 to the fine bubble diffusers 706 is set at sixty percent of the flow recommended by the diffuser manufacturers. This air flow rate setting ensures that the bubbles emitted by the fine bubble diffusers 706 dissolve in or below the thermocline layer, maximizing oxygen transfer efficiency while allowing remaining air capacity to be allocated to other aeration equipment in the system.

Referring to FIG. 4, the column of bubbles and aerated water formed by an operating diffuser is depicted in cross-sectional view showing the vertical structure of bubble formation and movement from the bottom of body of water 316 to the surface of body of water 318. The weighted air line 704 extends downward from a compressor and connects to the fine bubble diffuser 706 positioned at the bottom of body of water 316. The fine bubble diffuser 706 receives compressed air through the weighted air line 704 and emits bubbles that rise upward through the water column, forming the bubble column 708 that extends vertically toward the surface. The thermocline 612 is positioned horizontally between the bottom of body of water 316 and the surface of body of water 318, representing the transitional layer between warmer surface waters and colder bottom waters.

With continued reference to FIG. 4, the bubble column 708 is divided into three distinct zones based on bubble characteristics and behavior as the bubbles rise through the water column. The bubble zone 1 804 is located directly above the fine bubble diffuser 706 at the bottom of body of water 316 and forms the diffuser zone where bubbles initially emerge from the fine bubble diffuser 706. The bubble zone 1 804 extends approximately 5 feet above the fine bubble diffuser 706 and appears as thick smoke because the swirling bubble mass does not allow light to pass through. Within the bubble zone 1 804, approximately 50 percent of fine bubbles form and dissolve immediately into the open water as the bubbles emerge from the fine bubble diffuser 706. The remaining 50 percent of fine bubbles combine to form larger bubbles that begin to rise through the water column toward the bubble zone 2 806.

As further shown in FIG. 4, the bubble zone 2 806 is positioned directly above the bubble zone 1 804 and below the thermocline 612. The bubble zone 2 806 extends approximately 5 to 10 feet in length and contains a bubble mass that is less dense than the bubble mass in the bubble zone 1 804 below. Within the bubble zone 2 806, the rising bubbles consist of approximately 20 percent fine bubbles and 80 percent coarse bubbles. Light passes through the moving cluster of bubbles in the bubble zone 2 806 due to the reduced bubble density compared to the bubble zone 1 804. The water within the bubble zone 2 806 is partially saturated with air, causing the bubbles to dissolve slower than in the bubble zone 1 804. The bubbles within the bubble zone 2 806 continue combining to form larger bubbles that expand and rise faster as the bubbles ascend through the water column.

With continued reference to FIG. 4, the bubble zone 3 808 starts at approximately 15 to 20 feet above the fine bubble diffuser 706 and extends toward the surface of body of water 318. The bubble zone 3 808 contains predominantly coarse bubbles or larger, with light easily passing through the rising column of bubbles. The individual coarse bubbles within the bubble zone 3 808 continue to expand as the bubbles rise toward the surface due to reduced water pressure at shallower depths. Over 90 percent of the initial bubbles emitted by the fine bubble diffuser 706 dissolve into the open body of water as the bubbles pass through the bubble zone 1 804 and the bubble zone 2 806. The dissolved bubbles do not lift water, resulting in limited water circulation from the bottom of body of water 316 to the surface of body of water 318. The water lifted by the bubble column 708 is already saturated with air and cannot absorb additional oxygen from the atmosphere when the water reaches the surface of body of water 318. The fine bubble diffuser 706 systems are efficient at aerating vertical columns of water but absorb little or no oxygen at the water-atmosphere interface and result in limited horizontal circulation across the surface of body of water 318.

Referring to FIG. 5, an isometric plan view of the big bubble circulator 100 illustrates the structural arrangement and components of the device. The big bubble circulator 100 includes the first vertical tube 102 that forms the main cylindrical body of the device and provides the outer structural enclosure. The upper end plate 110 is positioned at the top of the first vertical tube 102 and includes the second vertical tube hole 107 located centrally within the upper end plate 110. The second vertical tube hole 107 provides an opening through which air and water exit the device during operation.

With continued reference to FIG. 5, the flood holes 114 are positioned around the circumference of the first vertical tube 102 at a lower portion of the tube. The flood holes 114 allow outside water to enter the interior of the big bubble circulator 100 to form the flooded reservoir below an internal lower endplate. The main air inlet 116a is connected to the upper portion of the big bubble circulator 100 and provides a connection point for compressed air to enter the device from a weighted air line. The main air inlet 116a delivers compressed air into the expansion chamber where the air accumulates before forming bubbles.

As further shown in FIG. 5, the eyebolt 126 and the eyebolt 128 are installed through the upper end plate 110 on opposite sides of the second vertical tube hole 107. The eyebolt 126 and the eyebolt 128 are positioned approximately 180 degrees apart and serve as attachment points for lifting and lowering the big bubble circulator 100 into a body of water during installation and maintenance operations.

With continued reference to FIG. 5, the big bubble circulator 100 is constructed from metals or rigid plastics resistant to degradation from salt or fresh water. The material composition allows the big bubble circulator 100 to withstand prolonged submersion in various aquatic environments without deterioration of structural integrity or functional performance. The big bubble circulator 100 is scalable and is made in various sizes when the proportions of the components remain constant relative to one another. The scalable design allows the big bubble circulator 100 to be sized appropriately for different body of water depths and circulation requirements while maintaining the operational characteristics and bubble formation properties of the device.

Referring to FIG. 6, a top plan view of the big bubble circulator 100 illustrates the concentric arrangement of components and the configuration of air inlets and lifting attachments. The first vertical tube 102 forms the outer cylindrical structure of the big bubble circulator 100 and defines the outermost boundary of the device when viewed from above. The second vertical tube 106 is positioned concentrically within the first vertical tube 102 and is visible through the second vertical tube hole 107 located at the center of the upper end plate 110. The upper end plate 110 is an annular structure that spans between the first vertical tube 102 and the second vertical tube 106, forming a sealed upper boundary for the expansion chamber within the device.

With continued reference to FIG. 6, the ballast 104 is visible at the base of the first vertical tube 102 and provides weight to overcome the buoyancy of the big bubble circulator 100 when submerged in water. The lower portion 133 of the device corresponds to the area where the first vertical tube 102 interfaces with the ballast 104. The lower portion 133 represents the structural connection between the cylindrical body of the big bubble circulator 100 and the weighted base that anchors the device at the bottom of a body of water during operation.

As further shown in FIG. 6, the main air inlet 116a is positioned on the exterior of the first vertical tube 102 and connects to the air inlet 116b and the air inlet 116c. The air inlet 116b and the air inlet 116c are positioned approximately 180 degrees apart on the upper end plate 110. The positioning of the air inlet 116b and the air inlet 116c at 180 degrees apart allows compressed air to flow evenly into the expansion chamber to equalize the pressure within the device. The dual inlet configuration ensures uniform air distribution within the expansion chamber, promoting consistent bubble formation and preventing pressure imbalances that would otherwise affect the generation of the super bubble 202.

With continued reference to FIG. 6, the eyebolt 126 and the eyebolt 128 are installed through the upper end plate 110 and are positioned approximately 180 degrees apart from each other. The eyebolt 126 and the eyebolt 128 provide attachment points for lifting and lowering the big bubble circulator 100 into and out of the body of water 315 during installation and maintenance operations. The positioning of the eyebolt 126 and the eyebolt 128 at 180 degrees apart provides balanced lifting points that distribute the weight of the big bubble circulator 100 evenly during handling, preventing tilting or uneven loading when the device is raised or lowered into position at the bottom of body of water 316.

Referring to FIG. 7, a cross-sectional view through section A-A of the big bubble circulator 100 without water reveals the internal structure and spatial relationships between the various chambers and components that facilitate bubble formation. The first vertical tube 102 forms the outer cylindrical structure of the big bubble circulator 100 and provides the primary structural enclosure for the internal components. The upper end plate 110 is positioned at the top of the first vertical tube 102 and includes the second vertical tube hole 107 at the center of the upper end plate 110. The second vertical tube 106 extends downward from the upper end plate 110 into the interior of the first vertical tube 102, with the second vertical tube hole 107 aligned with the opening of the second vertical tube 106.

With continued reference to FIG. 7, the expansion chamber 108 is defined in the annular space between the first vertical tube 102 and the second vertical tube 106. The expansion chamber 108 extends vertically from the lower endplate 112 to the upper end plate 110 and serves as the region where compressed air accumulates before forming bubbles. The expansion chamber 108 receives compressed air through the main air inlet 116a and distributes the air uniformly throughout the annular space. The main chamber 132 is defined within the interior of the second vertical tube 106 and provides the space where bubbles form and rise toward the second vertical tube hole 107.

As further shown in FIG. 7, the third vertical tube 119 extends upward from the lower endplate 112 and is positioned concentrically within the first vertical tube 102. The third vertical tube 119 includes the lower flat radial edge 121 at the upper terminus of the third vertical tube 119. The hole 122 is formed through the lower endplate 112 and aligns with the second vertical tube hole 107, providing a pathway for water to flow from the flooded reservoir 206 into the main chamber 132. The second chamber 131 is formed between the second vertical tube 106 and the third vertical tube 119, occupying the space where the proximal end of the second vertical tube 106 and the distal end of the third vertical tube 119 do not touch.

With continued reference to FIG. 7, the opening 118 provides communication between the expansion chamber 108 and the second chamber 131. The opening 118 is defined by the lower flat radial edge 121 of the third vertical tube 119 and the upper sharp beveled radial edge 124 of the second vertical tube 106. The lower flat radial edge 121 forms the lower boundary of the opening 118, with the interior and exterior wall of the third vertical tube 119 perpendicular to the second vertical tube 106. The upper sharp beveled radial edge 124 forms the upper boundary of the opening 118 and shears the compressed air mass as the air moves from the expansion chamber 108 into the second chamber 131. The angled surface of the upper sharp beveled radial edge 124 faces towards the main chamber 132.

As further shown in FIG. 7, the flooded reservoir 206 is located below the lower endplate 112 and is bounded by the ballast 104 and the lower endplate 112. The flood holes 114 extend through the wall of the first vertical tube 102 at a lower portion to allow water to enter the flooded reservoir 206 from the surrounding body of water 315. The flooded reservoir 206 provides a supply of water that is drawn upward through the hole 122 and into the main chamber 132 during bubble formation and release.

With continued reference to FIG. 7, the second vertical tube 106 is attached to the upper end plate 110 by welding, adhesive, or mechanical seals with an appropriate gasket. The attachment forms an airtight seal between the second vertical tube 106 and the upper end plate 110, preventing compressed air from escaping at the junction between these components. The bonding method for the upper end plate 110 to the first vertical tube 102 is welding, adhesive, or other suitable mechanical means with a proper gasket. The bonding around the entire circumference where the upper end plate 110 contacts the first vertical tube 102 and the second vertical tube 106 ensures that the expansion chamber 108 remains sealed during operation.

As further shown in FIG. 7, additional air inlets are incorporated into the design to ensure uniform air flow into the expansion chamber 108. The air inlet 116b and the air inlet 116 c are positioned 180 degrees apart on the upper end plate 110, and additional air inlets are added at intermediate positions around the circumference of the upper end plate 110 to further equalize pressure distribution within the expansion chamber 108. The uniform air flow into the expansion chamber 108 promotes consistent bubble formation by ensuring that compressed air enters the second chamber 131 through the opening 118 at an equalized pressure across the entire circumference of the opening 118.

Referring to FIG. 8, a cross-sectional view through section A-A of the big bubble circulator without water shows reference dimensions that define the proportional relationships between the various components. The expansion chamber height L2 represents the vertical distance from the lower endplate 112 to the upper end plate 110 and defines the height of the expansion chamber 108 where compressed air accumulates before forming bubbles. The expansion chamber height L2 equals ⅔ of the total distance L, where L represents the overall length of the first vertical tube 102 above the ballast 104 plus the ballast depth L7.

With continued reference to FIG. 8, the tube length above ballast L3 indicates the minimum length of the first vertical tube 102 extending above the ballast 104. The tube length above ballast L3 is specified as three times the diameter of the first vertical tube 102. This dimensional relationship ensures that the first vertical tube 102 provides sufficient height above the ballast 104 to accommodate the expansion chamber 108, the flooded reservoir 206, and the various internal components that facilitate bubble formation and water circulation.

As further shown in FIG. 8, the second vertical tube length L4 represents the length of the second vertical tube 106 that extends into the first vertical tube 102 cavity from the upper end plate 110 toward the lower endplate 112. The second vertical tube length L4 is between 40 to 90 percent of the expansion chamber height L2. This range allows the second vertical tube 106 to extend sufficiently into the expansion chamber 108 to receive compressed air through the opening 118 while providing adequate space for the second chamber 131 and the main chamber 132 where bubbles form before exiting through the second vertical tube hole 107.

With continued reference to FIG. 8, the opening height L5 indicates the vertical position of the lower flat radial edge 121 that forms a lower boundary between the first vertical tube 102 and the second vertical tube 106, measured from the lower endplate 112. The dimension of the opening 118 is ten to thirty percent of the expansion chamber height L2, with a preferred dimension of 15 percent of the expansion chamber height L2. The opening 118 connects the expansion chamber 108 to the second chamber 131 and controls the flow of compressed air from the expansion chamber 108 into the bubble-forming region of the big bubble circulator 100.

As further shown in FIG. 8, the second vertical tube interior length L6 represents the interior length of the second vertical tube 106 and equals 20 to 90 percent of the expansion chamber height L2. The ballast depth L7 indicates the portion of the first vertical tube 102 that is secured within the ballast 104. The ballast depth L7 is approximately one-sixth of the total length of the first vertical tube 102, ensuring that the big bubble circulator 100 remains anchored at the bottom of body of water 316 during operation.

With continued reference to FIG. 8, the flood hole position L8 indicates the vertical position where the series of flood holes 114 are centered. The flood hole position L8 is approximately one-third of the distance from the vertical tube proximal end to the vertical tube distal end. The flood holes 114 have a diameter approximately equal to one-sixth of the distance from the vertical tube proximal end to the vertical tube distal end. This positioning allows water from the surrounding body of water 315 to enter the flooded reservoir 206 located below the lower endplate 112.

The diameter of the first vertical tube 102 is selected from dimensions ranging from 3 to 48 inches, with a preferred diameter of 12 inches. The first vertical tube 102 has a minimum diameter of three times the diameter of the second vertical tube 106. This diameter ratio ensures that the expansion chamber 108 formed in the annular space between the first vertical tube 102 and the second vertical tube 106 has sufficient volume to accumulate compressed air before bubble formation.

The second vertical tube hole 107 has a dimension from one-tenth to one-third of the diameter of the first vertical tube 102. This dimensional range determines the size of the super bubble 202 that exits the big bubble circulator 100, with the second vertical tube hole 107 being approximately one inch smaller than the anticipated super bubble 202 diameter.

The upper end plate 110 has a minimum thickness of one quarter of the diameter of the second vertical tube 106. The lower endplate 112 has a minimum thickness of one eighth of the diameter of the second vertical tube 106. These thickness specifications ensure structural integrity of the upper end plate 110 and the lower endplate 112 under the pressure differentials that occur during operation of the big bubble circulator 100.

The lower flat radial edge 121 of the opening of the third vertical tube 119 is from 0 to 45 degrees from perpendicular, with a preferred angle of 0 degrees. The upper sharp beveled radial edge 124 of the second vertical tube 106 is 30 to 85 degrees from perpendicular, with a preferred angle of 45 degrees. The angled surface of the upper sharp beveled radial edge 124 faces towards the main chamber 132. The upper sharp beveled radial edge 124 shears the compressed air mass as the air moves through the opening 118 to form the second air bubble 202a within the second chamber 131.

The ballast 104 is formed from suitable materials such as concrete, metal, or epoxy. The material selection for the ballast 104 provides sufficient weight to overcome the buoyancy of the big bubble circulator 100 when submerged in water while maintaining compatibility with the aquatic environment.

The pump 400 for facultative lagoon applications incorporates a taller unit geometry optimized for deeper water columns typical of facultative lagoons at 4 to 8 feet depth. The pump 400 is constructed from HDPE rated for wastewater environments. The diffuser coil 440 spirals around the outer surface of the pump cylinder 450 and provides fine-bubble aeration in addition to the large-bubble circulation generated by the bubble tube 490.

The pump 400 incorporates a dual air supply design where the first air inlet 410 feeds the diffuser coil 440 for dissolved oxygen generation and the second air inlet 420 feeds the pump cavity for large-bubble generation through the air conduit 430. This dual air supply configuration allows independent tuning of aeration versus circulation by adjusting the air flow to each inlet separately.

The vertical slots 470 extend along the upper perimeter of the cylindrical pump housing 402 and provide optimized water intake for the lagoon environment compared to round flood holes. The concrete cavity 460 is integrated into the base of the pump 400 and holds concrete that provides ballast to stabilize the pump 400 in the sludge layer 500 of the facultative lagoon.

The pump 400 is designed for multi-pump system deployment where multiple pumps are positioned to create overlapping ripple patterns that cover entire lagoon surfaces. The ripple pattern diagram 499 shown in FIG. 19 illustrates a three-pump system configuration where the concentric ripple patterns from each pump overlap and interact to provide comprehensive surface coverage across the facultative lagoon.

Referring to FIG. 9, the circulation pattern within the body of water 315 for the big bubble circulator 100 is depicted. The big bubble circulator 100 is positioned at the bottom of body of water 316 and generates the super bubbles 202 that rise in a column toward the surface of body of water 318. The super bubbles 202 increase in size as the super bubbles 202 rise from the big bubble circulator 100 toward the surface due to reduced water pressure at shallower depths. The big bubble circulator 100 produces approximately ten super bubbles 202 per second, equating to more than 300 gallons per minute of cold low oxygen water from the bottom of body of water 316 to the surface of body of water 318.

With continued reference to FIG. 9, the upper cover 304 is positioned at the surface of body of water 318 and spans the dimension 320 indicating the horizontal extent of the circulation effect produced by the big bubble circulator 100. The mound of water 302 forms at the surface of body of water 318 where the super bubbles 202 break through. The super bubbles 202 breaking at the surface create a stream of churning low oxygen cold water that flows across the body of water 315 up to 50 yards in all directions from the mound of water 302.

As further shown in FIG. 9, the oxygenated water 308 flows outward from the mound of water 302 across the surface of body of water 318. The vertical circulation zone 312 is established within the body of water 315, with water movement occurring downward along the outer edges of the vertical circulation zone 312 and upward through the center where the super bubbles 202 rise. The oxygenated water 308 at the surface of body of water 318 absorbs atmospheric oxygen as the oxygenated water 308 flows outward from the mound of water 302. The oxygenated water 308 eventually slows down and sinks back into the body of water 315 after flowing outward across the surface of body of water 318, completing the circulation pattern established by the vertical circulation zone 312.

Referring to FIG. 10, the forces acting on the super bubble 202 released from the big bubble circulator 100 are depicted. The big bubble circulator 100 is positioned at the bottom of the figure, and the super bubble 202 is shown above the big bubble circulator 100 as a hemispherical shape rising through the water column. The super bubble 202 experiences both upward and downward forces during ascent through the body of water 315.

With continued reference to FIG. 10, the upward force acting on the super bubble 202 is buoyancy, which results from the volume of water displaced by the super bubble 202 relative to the mass of the super bubble 202. The buoyancy force causes the super bubble 202 to rise through the water column because the air within the super bubble 202 is less dense than the surrounding water. As the super bubble 202 rises, the super bubble 202 increases in size due to reduced water pressure at shallower depths, which increases the buoyancy force and accelerates the rise velocity of the super bubble 202.

As further shown in FIG. 10, the downward forces acting on the super bubble 202 include gravity, the water being lifted 205, and the drafted water 204. Gravity acts on the mass of the super bubble 202, though this force is nominal because bubbles have minimal mass compared to the surrounding water. The water being lifted 205 is shown at the top of the super bubble 202 and represents the water that adheres to the upper surface of the super bubble 202 and is carried upward as the super bubble 202 rises. The drafted water 204 extends from the big bubble circulator 100 toward the super bubble 202 and represents the water being pulled upward behind the rising super bubble 202. The forces of the water being lifted 205 and the drafted water 204 are dependent on the size of the super bubble 202 and the velocity at which the super bubble 202 rises through the water column.

With continued reference to FIG. 10, the super bubble 202 ranges from 1 inch to 10 inches in diameter. The diameter of the super bubble 202 determines the buoyancy force, the rise velocity, and the volume of water that the super bubble 202 transports from the bottom of body of water 316 to the surface of body of water 318. A one-millimeter fine bubble rises at approximately 1 foot per minute. A five-inch super bubble rises at approximately 4 feet per minute. A nine-inch super bubble rises at 9 feet per minute. The increase in rise velocity with increasing bubble diameter results from the greater buoyancy force generated by larger bubbles displacing more water volume.

As further shown in FIG. 10, a nine-inch super bubble lifts and drafts approximately two quarts of cold low oxygen water from the bottom of body of water 316 to the surface of body of water 318. The water being lifted 205 adheres to the upper surface of the super bubble 202, and the drafted water 204 follows behind the super bubble 202 as the super bubble 202 rises through the water column. The combined volume of the water being lifted 205 and the drafted water 204 transported by each super bubble 202 contributes to the circulation of water within the body of water 315.

With continued reference to FIG. 10, the super bubble 202 starts out as a five-inch super bubble at the big bubble circulator 100 and expands to a nine-inch super bubble after rising 32 feet in water. The expansion of the super bubble 202 during ascent results from the decrease in water pressure 875 and gravity 875 as the super bubble 202 rises toward the surface of body of water 318. The expansion of the super bubble 202 increases the buoyancy force 877 acting on the super bubble 202, which increases the rise velocity from approximately 4 feet per minute at the five-inch diameter to 9 feet per minute at the nine-inch diameter. The expansion of the super bubble 202 also increases the volume of the water being lifted 205 and the drafted water 204 transported by the super bubble 202 as the super bubble 202 approaches the surface of body of water 318.

Referring to FIG. 11, a cross-sectional view through section A-A of the big bubble circulator with water present illustrates the internal structure and operation of the device during water circulation. The first vertical tube 102 forms the outer cylindrical structure of the big bubble circulator 100 and contains water that fills the various chambers and cavities within the device. The upper end plate 110 is positioned at the top of the first vertical tube 102 and includes the second vertical tube hole 107 at the center through which the super bubble 202 exits the device. The air inlet 116b and the air inlet 116c are positioned on the upper end plate 110 and deliver compressed air into the expansion chamber 108.

With continued reference to FIG. 11, compressed air enters the expansion chamber 108 through the air inlet 116b and the air inlet 116c. The compressed air accumulates within the expansion chamber 108 and forms the first bubble 105 as the air displaces water within the annular space between the first vertical tube 102 and the second vertical tube 106. The first bubble 105 expands throughout the expansion chamber 108 and pushes water downward through the opening 118 that connects the expansion chamber 108 to the second chamber 131. The expanding compressed air lifts the water because the air mass is less dense and therefore more buoyant than the water surrounding the big bubble circulator 100.

As further shown in FIG. 11, the opening 118 is defined by the lower flat radial edge 121 and the upper sharp beveled radial edge 124. The lower flat radial edge 121 forms the lower boundary of the opening 118 at the upper terminus of the third vertical tube 119. The upper sharp beveled radial edge 124 forms the upper boundary of the opening 118 at the lower end of the second vertical tube 106. As the first bubble 105 moves from the expansion chamber 108 through the opening 118, the upper sharp beveled radial edge 124 shears the compressed air mass to form the second air bubble 202a within the second chamber 131. The shearing action of the upper sharp beveled radial edge 124 separates the second air bubble 202a from the compressed air remaining in the expansion chamber 108.

With continued reference to FIG. 11, the lower endplate 112 is positioned within the first vertical tube 102 and separates the expansion chamber 108 from the flooded reservoir 206 located below. The lower endplate 112 includes the hole 122 at the center of the lower endplate 112. The hole 122 aligns with the second vertical tube hole 107 and provides a pathway for water to flow from the flooded reservoir 206 into the third vertical tube cavity 207. The flood holes 114 extend through the wall of the first vertical tube 102 at a lower portion and allow water from the surrounding body of water 315 to enter the flooded reservoir 206.

As further shown in FIG. 11, the third vertical tube cavity 207 is positioned below the second chamber 131 and connects the flooded reservoir 206 to the second chamber 131 through the hole 122 in the lower endplate 112. The third vertical tube cavity 207 provides a conduit through which water flows from the flooded reservoir 206 upward toward the second chamber 131 during bubble formation and release. When the second air bubble 202a forms within the second chamber 131, the buoyancy of the second air bubble 202a causes the second air bubble 202a to rise rapidly through the main chamber 132 toward the second vertical tube hole 107.

With continued reference to FIG. 11, the drafted water 204 is drawn upward from the flooded reservoir 206 through the third vertical tube cavity 207 and adheres to the bottom of the second air bubble 202a. The movement of the second air bubble 202a creates a drafting effect that pulls water from the flooded reservoir 206 upward behind the rising bubble. The water being lifted 205 adheres to the top of the second air bubble 202a as the second air bubble 202a rises through the main chamber 132. The water being lifted 205 is carried along the upper surface of the second air bubble 202a and is transported upward toward the second vertical tube hole 107.

As further shown in FIG. 11, the second air bubble 202a exits through the second vertical tube hole 107 and forms the super bubble 202 above the big bubble circulator 100. The super bubble 202 rises toward the surface of body of water 318 with the drafted water 204 following behind and the water being lifted 205 carried along the upper surface. The sequence of bubble formation, shearing, and release repeats multiple times each second as compressed air continues to enter the expansion chamber 108 through the air inlet 116b and the air inlet 116c.

The pump 400 for facultative lagoon applications provides algae control by raising dissolved oxygen in the aerobic layer to feed bacteria that consume nutrients required for algae growth. The bacteria consume the nutrients and starve the algae of the resources needed for proliferation. The pump 400 simultaneously creates surface ripples that diffuse light penetration into the water column, reducing photosynthesis that drives algae blooms. The ripples also create surface counterflow that pushes lighter algae and floating plants toward the edges of the lagoon rather than allowing the algae and floating plants to dominate the surface.

The pump 400 provides elevated effluent ammonia reduction by circulating ammonia-rich water from the anaerobic bottom layer up to the aerobic surface layer where nitrifying bacteria convert the ammonia. The pump 400 does not disturb the anaerobic sludge layer 500 where ammonia is generated, preserving the beneficial anaerobic digestion process at the bottom of the lagoon. Pumps positioned near the effluent weir create a thoroughly mixed zone that reduces ammonia levels before discharge.

The pump 400 provides elevated effluent BOD reduction through higher dissolved oxygen levels in the mixed aerobic zone that oxidize BOD before the BOD reaches the discharge weir. Ripples flowing from pump locations toward the far side of the lagoon and back create additional mixing and oxygen exposure time for the wastewater.

The pump 400 provides elevated effluent suspended solids reduction through controlled algae growth that directly reduces suspended solids in effluent. The pump 400 provides odor control by preventing seasonal turnover events that release trapped gases through maintaining continuous circulation. The pump 400 controls algae blooms which keeps pH lower and keeps odorous ammonia and mercaptans soluble rather than off gassing into the atmosphere.

The pump 400 provides mosquito and water-borne insect control through a continuous 24/7 ripple field across the entire lagoon surface that prevents egg-laying on hot windless days or overnight. The ripple field disrupts stagnant zones where vegetation mats form and provide breeding habitat for insects.

The pump 400 provides ice prevention by bringing non-frozen aerobic water to the surface and creating ripples that keep a large area of the lagoon from icing over, maintaining treatment capacity through winter. The pump 400 provides plug flow optimization through ripples that create a surface counterflow to the lagoon's natural inlet-to-outlet flow, promoting more even plug flow distribution across the entire lagoon rather than short-circuiting.

The pump 400 addresses regulatory compliance by directly addressing the most common causes of Clean Water Act violations in lagoon systems including effluent ammonia, BOD, suspended solids, and odor complaints. The pump 400 provides low total cost of ownership compared to mechanical alternatives through the absence of in-water electricity, the absence of moving parts, and minimal maintenance requirements.

The pump 400 preserves the beneficial anaerobic digestion process at the bottom of the lagoon while improving aerobic zone performance by not disturbing the anaerobic sludge layer 500. The pump 400 provides sludge accumulation reduction through improved aerobic digestion in the upper layers that reduces the rate of organic material settling into the sludge layer 500, extending the interval between dredging operations.

The pump 400 provides reduced chemical treatment requirements through improved circulation, oxygenation, and algae control that reduce or eliminate the need for chemical algaecides, copper sulfate treatments, and other chemical interventions. The pump 400 provides extended lagoon operational lifespan through reduced sludge buildup, improved treatment performance, and elimination of mechanical wear due to the absence of in-water motors and moving parts.

Referring to FIG. 12, a cross-sectional view of a body of water incorporating the big bubble circulator 100 into an aeration system depicts the arrangement and operation of components that deliver dissolved oxygen and circulation throughout the water column. The compressor station 702 is positioned on shore above the surface of body of water 318 and generates compressed air that is distributed to submerged aeration equipment positioned at the bottom of body of water 316. The compressor station 702 connects to multiple weighted air lines 704 that extend downward through the body of water to the bottom of body of water 316.

With continued reference to FIG. 12, the weighted air lines 704 deliver compressed air from the compressor station 702 to the fine bubble diffusers 706 and the diffuser 502 positioned at the bottom of body of water 316. The fine bubble diffusers 706 are located on either side of the big bubble circulator 100 and emit small bubbles that rise through the water column, dissolving oxygen into the surrounding water during ascent. The diffuser 502 is positioned adjacent to the big bubble circulator 100 and provides additional fine-bubble aeration in the vicinity of the big bubble circulator 100.

As further shown in FIG. 12, the big bubble circulator 100 creates the vertical circulation zone 312 that extends from the bottom of body of water 316 toward the surface of body of water 318. The vertical circulation zone 312 is established between the fine bubble diffusers 706 positioned on either side of the big bubble circulator 100. The oxygenated water 308 flows across the surface of body of water 318 after being lifted by the big bubble circulator 100 from the bottom of body of water 316. The atmospheric oxygen 317 is absorbed by the water at the surface of body of water 318 as the oxygenated water 308 flows outward from the mound of water formed above the big bubble circulator 100.

With continued reference to FIG. 12, the thermocline 612 is indicated within the body of water between the surface of body of water 318 and the bottom of body of water 316. The big bubble circulator 100 draws cold, oxygen-depleted water from below the thermocline 612 and lifts the water to the surface of body of water 318 where the water absorbs the atmospheric oxygen 317 across a wide area. The oxygenated water 308 flows horizontally across the surface of body of water 318 above the thermocline 612, absorbing the atmospheric oxygen 317 through gas exchange at the air-water interface before eventually sinking back into the body of water.

The flow of air from the compressor station 702 through the individual weighted air lines 704 to the fine bubble diffusers 706 is set at sixty percent of the flow recommended by the diffuser manufacturers to ensure that the bubbles emitted dissolve in or below the thermocline 612. The remainder of the air available from the compressor station 702 is divided evenly to any big bubble circulators 100 in the system. This air distribution configuration allows the fine bubble diffusers 706 to provide vertical mixing and dissolved oxygen saturation while the big bubble circulator 100 adds horizontal surface circulation that the fine bubble diffusers 706 do not provide.

The compressor station 702 includes pumps selected based on the depth of the body of water. Rocking piston pumps are used on deeper lake or pond applications where the depth is greater than 6 feet. Diaphragm pumps are used for shallow applications where the depth is less than 6 feet. The selection of pump type based on depth ensures efficient air delivery to the submerged aeration equipment while minimizing energy consumption.

The integrated aeration system incorporating the big bubble circulator 100 with the fine bubble diffusers 706 and the diffuser 502 is applicable to municipal facultative lagoon wastewater treatment, EPA-permitted lagoon facilities, small community wastewater treatment systems, industrial wastewater lagoons, and facultative lagoon systems facing compliance issues with effluent quality. The combination of fine-bubble aeration from the fine bubble diffusers 706 and the diffuser 502 with large-bubble circulation from the big bubble circulator 100 provides both dissolved oxygen saturation and horizontal surface circulation across the body of water.

Referring to FIG. 13, the facultative lagoon diagram 399 depicts the layered structure and biological processes within a facultative lagoon used for wastewater treatment. The facultative lagoon diagram 399 shows three distinct zones arranged vertically within the water body, with each zone characterized by different levels of sunlight penetration, dissolved oxygen concentration, and bacterial activity. Sunlight energy enters the system from above, and the wind 614 provides surface aeration across the water surface by creating movement and gas exchange at the air-water interface.

With continued reference to FIG. 13, the uppermost layer is identified as the aerobic zone, which receives sunlight and contains dissolved oxygen. Within the aerobic zone, algae perform photosynthesis and produce oxygen that contributes to the dissolved oxygen content of the water. Aerobic bacteria within the aerobic zone consume organic matter using the available dissolved oxygen. The aerobic zone serves as a barrier for odor control by maintaining aerobic conditions at the surface that prevent the release of odorous compounds generated in lower zones.

As further shown in FIG. 13, the middle layer is designated as the facultative zone, which is characterized by some sunlight penetration and some dissolved oxygen. The facultative zone contains facultative bacteria that function in both aerobic and anaerobic conditions to treat wastewater. The facultative bacteria adapt to the varying oxygen levels within the facultative zone and continue metabolic processes regardless of whether oxygen is present or absent. Carbon dioxide is released from the facultative zone as a byproduct of bacterial metabolism.

With continued reference to FIG. 13, the bottom layer is labeled as the anaerobic zone, which receives no sunlight and contains no dissolved oxygen. The anaerobic zone houses anaerobic bacteria that process organic material without oxygen through anaerobic digestion. The anaerobic zone contains the sludge layer 500 at the bottom of the lagoon where anaerobic bacteria, sludge worms, and microscopic organisms treat the wastewater. Nutrients and gases move upward from the anaerobic zone toward the upper layers as byproducts of anaerobic decomposition processes.

As further shown in FIG. 13, the facultative lagoon diagram 399 illustrates the symbiotic relationship between the zones, where the aerobic surface layer provides oxygen and odor control, the facultative middle layer provides transitional treatment, and the anaerobic bottom layer handles sludge decomposition and nutrient release. The wind 614 provides surface aeration by moving across the water surface and creating agitation that promotes gas exchange between the atmosphere and the aerobic zone. The movement of nutrients and gases between zones supports the biological treatment processes occurring within each layer.

Typical design criteria for facultative lagoons include detention of 20 to 180 days, depth of 4 to 8 feet, organic loading of 10 to 100 pounds of biological oxygen demand per acre per day, and temperature above 68 degrees Fahrenheit. The detention time allows sufficient contact between wastewater and the bacterial populations within each zone to achieve treatment objectives. The depth range of 4 to 8 feet accommodates the formation of the three distinct zones while allowing sunlight to penetrate into the facultative zone. The organic loading rate determines the amount of biodegradable material introduced to the lagoon relative to the surface area available for treatment. The temperature threshold of 68 degrees Fahrenheit supports the metabolic activity of the bacterial populations responsible for wastewater treatment within the aerobic, facultative, and anaerobic zones.

Referring to FIG. 14, a diagram shows the pump 400 providing water circulation in the layers of a facultative lagoon. The pump 400 is positioned within the facultative lagoon environment with an air supply line extending above the water surface to receive compressed air from an external source. The air supply line connects the pump 400 to compressors located on shore, delivering compressed air that drives the aeration and circulation processes within the pump 400.

With continued reference to FIG. 14, a mixing zone is positioned adjacent to the pump 400 where water circulation occurs. The mixing zone extends approximately 23 inches in height and represents the region where water from the upper aerobic zone flows downward into the pump 400, receives aeration through the diffuser coil 440, and is lifted upward through the bubble tube 490 by large bubbles generated within the pump cavity. The mixing zone facilitates the combination of aerated water with water drawn from the surrounding lagoon environment.

As further shown in FIG. 14, the pump 400 operates within the stratified layers of the facultative lagoon including the aerobic zone near the surface, the facultative zone in the middle region, and the anaerobic zone at the bottom. Water flows from the upper aerobic zone downward into the mixing zone, through the pump 400, and back up over the surface. The pump 400 does not disturb the sludge layer 500 at the base of the lagoon, preserving the integrity of the anaerobic zone where anaerobic bacteria perform sludge decomposition. The circulation pattern established by the pump 400 draws water from the aerobic zone rather than from the anaerobic zone, maintaining the distinct stratification that supports the biological treatment processes within each layer.

With continued reference to FIG. 14, the diagram depicts a minimum depth requirement of 3 feet for the water column in which the pump 400 operates. An approximate minimum depth of water for operation is 30 inches. This minimum depth ensures that the pump 400 has sufficient water column height to generate large bubbles that rise to the surface and create the circulation patterns that distribute oxygenated water across the lagoon surface. The 30-inch minimum depth accommodates the height of the pump 400 and provides adequate water above the pump 400 for bubble formation and release through the bubble tube 490.

As further shown in FIG. 14, the taller unit geometry of the pump 400 is optimized for deeper water columns typical of facultative lagoons at 4 to 8 feet depth. The taller geometry allows the pump 400 to draw water from the aerobic zone at the surface and circulate the water through the mixing zone without disturbing the lower anaerobic zone. The vertical extent of the pump 400 positions the lower openings 480 and the diffuser coil 440 within the aerobic and facultative zones where oxygen transfer and bacterial activity occur, while the concrete cavity 460 at the base of the pump 400 anchors the pump 400 in the sludge layer 500 without disrupting the anaerobic processes occurring within the sludge layer 500.

Referring to FIG. 15, a side elevational view of the pump 400 positioned in a facultative lagoon environment illustrates the structural arrangement and configuration of components that facilitate aeration and circulation within the lagoon. The pump 400 includes the cylindrical pump housing 402 that provides the outer structural enclosure for the device and defines the overall shape of the pump 400. The cylindrical pump housing 402 features the plurality of vertical slots 470 extending along the upper perimeter of the cylindrical pump housing 402. The vertical slots 470 allow water flow through the cylindrical pump housing 402 and into the interior of the pump 400 where aeration and circulation processes occur.

With continued reference to FIG. 15, the vertical slots 470 along the upper perimeter of the cylindrical pump housing 402 differ from the round flood holes 114 used in the big bubble circulator 100. The vertical slots 470 provide optimized water intake for the lagoon environment by allowing water to enter the pump 400 across a greater vertical extent of the cylindrical pump housing 402 compared to discrete round openings. The vertical orientation of the vertical slots 470 facilitates water flow from the upper aerobic zone of the facultative lagoon into the pump 400 while minimizing the intake of particulate matter and debris that accumulates at lower depths within the lagoon.

As further shown in FIG. 15, the pump cylinder 450 is aligned concentrically within the cylindrical pump housing 402. The pump cylinder 450 has an outer surface and an inner surface that define a pump cavity contained within the pump cylinder 450. The bubble tube 490 is positioned concentrically inside the pump cylinder 450 and extends vertically through the central portion of the pump cylinder 450. The bubble tube 490 provides a pathway through which large bubbles rise and exit the pump 400, forcing water in an upward direction toward the surface of the facultative lagoon.

With continued reference to FIG. 15, the diffuser coil 440 extends spirally adjacent to the outer surface of the pump cylinder 450. The diffuser coil 440 is positioned within the annular space between the pump cylinder 450 and the cylindrical pump housing 402. The diffuser coil 440 receives compressed air through the first air inlet 410 and emits micro-bubbles that dissolve into the water flowing through the pump 400. The micro-bubbles generated by the diffuser coil 440 oxygenate the water within the mixing zone of the pump 400 before the water is lifted to the surface by large bubbles rising through the bubble tube 490.

As further shown in FIG. 15, the first air inlet 410 is positioned at an upper portion of the pump 400 for attachment to a first air supply. The first air inlet 410 is connected to the diffuser coil 440 and delivers compressed air that flows through the diffuser coil 440 to generate micro-bubbles for aeration. The second air inlet 420 is positioned at the upper portion of the pump 400 for attachment to a second air supply. The air conduit 430 has a first end attached to the second air inlet 420 and extends downward into the pump structure, with a second end terminating in the pump cavity through the upper cover 455. The air conduit 430 delivers compressed air into the pump cavity where large bubbles form and rise through the bubble tube 490.

With continued reference to FIG. 15, the pump cylinder 450 includes the plurality of lower openings 480 extending through a lower portion of the pump cylinder 450. The lower openings 480 allow water to enter the pump cavity from the surrounding lagoon environment. Water flows through the lower openings 480 into the pump cavity where the water mixes with micro-bubbles generated by the diffuser coil 440 and is subsequently lifted upward by large bubbles rising through the bubble tube 490.

As further shown in FIG. 15, the concrete cavity 460 is disposed below the pump cylinder 450 at the base of the pump 400. The concrete cavity 460 holds concrete that provides ballast to stabilize the pump 400 in position within the facultative lagoon. The weight of the concrete within the concrete cavity 460 overcomes the buoyancy of the pump 400 when submerged in water and anchors the pump 400 at the bottom of the lagoon during operation.

With continued reference to FIG. 15, the pump 400 is shown positioned within the lagoon environment with the sludge layer 500 at the bottom of the lagoon and the light sludge layer 510 positioned above the sludge layer 500. The sludge layer 500 contains anaerobic bacteria, sludge worms, and microscopic organisms that treat wastewater through anaerobic digestion processes. The light sludge layer 510 represents a transitional zone between the denser sludge layer 500 and the water column above where facultative and aerobic processes occur.

As further shown in FIG. 15, the pump 400 does not disturb the sludge layer 500 while water flows in from the upper aerobic zone. The lower openings 480 are positioned at a lower portion of the pump cylinder 450 that draws water from the aerobic and facultative zones above the sludge layer 500 rather than from the anaerobic zone within the sludge layer 500. The vertical slots 470 along the upper perimeter of the cylindrical pump housing 402 facilitate water intake from the upper aerobic zone, directing water flow downward into the pump 400 and through the lower openings 480 into the pump cavity. This water flow pattern preserves the integrity of the sludge layer 500 and maintains the anaerobic conditions within the sludge layer 500 that support beneficial anaerobic digestion processes. The pump 400 circulates water from the aerobic zone through the mixing zone and back to the surface without disrupting the stratification that separates the aerobic, facultative, and anaerobic zones within the facultative lagoon.

Referring to FIG. 16, a top plan view of the pump 400 illustrates the concentric arrangement of components that facilitate aeration and circulation within a facultative lagoon. The cylindrical pump housing 402 forms the outermost boundary of the pump 400 when viewed from above and provides the structural enclosure that contains the internal components of the device. The cylindrical pump housing 402 defines the overall diameter of the pump 400 and establishes the outer perimeter within which water intake and circulation processes occur.

With continued reference to FIG. 16, the pump cylinder 450 is positioned concentrically within the cylindrical pump housing 402. The pump cylinder 450 has an outer surface and an inner surface that define a pump cavity contained within the pump cylinder 450. The upper cover 455 is positioned at the top of the pump cylinder 450 and includes the center opening 457 located centrally within the upper cover 455. The upper cover 455 functions to prevent air from exiting the pump cavity at an upper cavity portion, directing air flow through the center opening 457 rather than allowing air to escape around the perimeter of the pump cylinder 450.

As further shown in FIG. 16, the bubble tube 490 is aligned concentrically inside the pump cylinder 450. The center opening 457 of the upper cover 455 aligns with the bubble tube 490, providing a pathway through which large bubbles exit the pump 400 and rise toward the surface of the facultative lagoon. The bubble tube 490 extends vertically through the central portion of the pump cylinder 450 and is shorter than the pump cylinder 450, allowing space within the pump cavity for bubble formation before the bubbles rise through the bubble tube 490 and exit through the center opening 457.

With continued reference to FIG. 16, the diffuser coil 440 extends spirally in the annular space between the pump cylinder 450 and the cylindrical pump housing 402. The diffuser coil 440 is positioned adjacent to the outer surface of the pump cylinder 450 and spirals around the pump cylinder 450 within the annular region defined by the inner surface of the cylindrical pump housing 402 and the outer surface of the pump cylinder 450. The spiral configuration of the diffuser coil 440 provides an extended length of diffuser material within the compact annular space, increasing the surface area available for micro-bubble generation and oxygen transfer into the water flowing through the pump 400.

As further shown in FIG. 16, the first air inlet 410 is positioned at an upper portion of the pump 400 for attachment to a first air supply. The first air inlet 410 is connected to the diffuser coil 440 and delivers compressed air that flows through the diffuser coil 440. The compressed air flowing through the diffuser coil 440 generates micro-bubbles that dissolve into the water within the annular space between the pump cylinder 450 and the cylindrical pump housing 402, oxygenating the water before the water enters the pump cavity through the lower openings.

With continued reference to FIG. 16, the second air inlet 420 is positioned at the upper portion of the pump 400 for attachment to a second air supply. The air conduit 430 has a first end attached to the second air inlet 420 and extends through the upper cover 455 into the pump cavity. The second end of the air conduit 430 terminates within the pump cavity, delivering compressed air that forms large bubbles within the pump cavity. The large bubbles rise through the bubble tube 490 and exit through the center opening 457, forcing water in an upward direction toward the surface of the facultative lagoon.

As further shown in FIG. 16, the top plan view reveals the spatial relationship between the concentric components of the pump 400. The bubble tube 490 occupies the central position, surrounded by the pump cylinder 450 with the upper cover 455 spanning the top of the pump cylinder 450. The diffuser coil 440 spirals around the pump cylinder 450 in the annular space, and the cylindrical pump housing 402 forms the outermost boundary of the assembly. The first air inlet 410 and the second air inlet 420 are positioned to deliver compressed air to the diffuser coil 440 and the pump cavity respectively, with the air conduit 430 extending from the second air inlet 420 through the upper cover 455 to deliver air into the pump cavity for large bubble generation.

Referring to FIG. 17, a side elevational view of the pump 400 with the housing removed reveals the internal components and their arrangement within the device. The cylindrical pump housing 402 provides the outer structural framework that contains and supports the internal components of the pump 400. The cylindrical pump housing 402 is shown in outline form to illustrate the spatial relationships between the components positioned within the interior of the pump 400.

With continued reference to FIG. 17, the first air inlet 410 is positioned at an upper portion of the pump 400 and receives compressed air from a first air supply delivered through a standard weighted airline from a shore-mounted compressor. The second air inlet 420 is positioned at the upper portion of the pump 400 and receives compressed air from a second air supply. The air conduit 430 has a first end attached to the second air inlet 420 and extends downward into the pump structure. The second flow 408 is indicated by an arrow showing the direction of air movement through the air conduit 430 into the pump cavity. The second flow 408 represents the compressed air that enters the pump cavity and forms large bubbles that rise through the bubble tube 490.

As further shown in FIG. 17, the diffuser coil 440 comprises multiple horizontal coil sections arranged vertically within the pump structure. The diffuser coil 440 extends spirally along the interior of the pump 400 and is positioned to facilitate mixing of air with water flowing through the pump 400. The diffuser coil 440 is similar to a soaker hose and receives compressed air through the first air inlet 410. The compressed air flowing through the diffuser coil 440 forms micro-bubbles within the pump mixing zone. The micro-bubbles dissolve into the water flowing through the pump 400, oxygenating the water before the water is lifted to the surface by large bubbles rising through the bubble tube 490.

With continued reference to FIG. 17, the bubble tube 490 is aligned concentrically within the pump 400 and extends vertically through the central portion of the pump structure. The bubble tube 490 provides a pathway through which large bubbles rise and exit the pump 400, forcing water in an upward direction toward the surface of the facultative lagoon. The short bottom tube 406 is positioned axially below the bubble tube 490. The short bottom tube 406 facilitates the formation of larger bubbles by providing a defined space below the bubble tube 490 where compressed air accumulates before rising through the bubble tube 490. The positioning of the short bottom tube 406 axially aligned under the bubble tube 490 promotes the generation of consecutive large bubbles that range from 4 to 5 inches in diameter.

As further shown in FIG. 17, the concrete cavity 460 is disposed at the lower portion of the pump 400 below the diffuser coil 440. The concrete cavity 460 is configured to hold concrete that provides ballast to stabilize the pump 400 in the sludge layer 500 of the facultative lagoon. The concrete cavity 460 is shown partially submerged in water, as indicated by the water line depicted at the base of the pump structure.

The pump 400 is manufactured from environmentally benign heavy-duty HDPE. The HDPE construction provides resistance to degradation from wastewater environments and ensures compatibility with the biological processes occurring within the facultative lagoon. The pump 400 weighs about 180 pounds and includes a sufficient amount of concrete within the concrete cavity 460 to keep the pump 400 stabilized in the sludge layer 500 of the facultative lagoon. The weight of the pump 400 combined with the concrete ballast allows the pump 400 to sink to the bottom of the lagoon under its own ballast weight during installation.

The pump 400 operates pneumatically with compressed air delivered from a shore-mounted compressor through standard weighted airlines. The pump 400 contains no electrical components and no moving parts in the water. The absence of electrical components eliminates electrical hazards in the water and reduces maintenance requirements. The absence of moving parts eliminates mechanical wear and provides a 20-year warranty on the unit due to the HDPE construction with no moving parts.

The second air inlet 420 creates hundreds of large bubbles that expand as the large bubbles rise to the surface, drafting and lifting water in an upward direction. The large bubbles generated by the pump 400 rise as a coherent column and displace water upward via a piston effect. The large bubbles create a pulsating surface dome approximately 10 inches high and 2 feet in diameter, displacing approximately 160 pounds of water per pulse. The pulsating surface dome collapses into radial surface waves that propagate horizontally across multiple acres, guided by the thermal density layering of the thermocline 612 within the body of water 315.

The pump 400 uses the same air infrastructure as traditional bottom-diffuser systems including compressors and airlines. The pump 400 is attached to the existing manifolds with zero new infrastructure required for installation. The pump 400 is connected by a single airline that delivers compressed air from the shore-mounted compressor to the first air inlet 410 and the second air inlet 420.

The pump 400 incorporates a scalable design where proportions remain constant across different unit sizes. The scalable design allows the pump 400 to be sized appropriately for different facultative lagoon depths and circulation requirements while maintaining the operational characteristics and bubble formation properties of the device.

The pump 400 operates silently with no motor noise, making the pump 400 suitable for residential, resort, golf course, and other noise-sensitive environments. The pump 400 contains no exposed moving parts in the water including no spinning blades, impellers, or propellers. The absence of exposed moving parts makes the pump 400 safe for fish, turtles, waterfowl, and other aquatic wildlife that inhabit the facultative lagoon.

The pump 400 is fully submerged with no surface obstruction during operation. The fully submerged configuration makes the pump 400 compatible with recreational use including swimming, boating, and fishing. The pump 400 presents no electrical hazard, no wake from mechanical equipment, and no visible hardware beyond the ripple pattern generated at the surface of body of water 318 by the large bubbles exiting the bubble tube 490.

Referring to FIG. 18, a cross-sectional view of the pump 400 reveals the internal arrangement and structure of the pump 400. The cylindrical pump housing 402 forms the outer enclosure of the pump 400, providing structural support and defining the overall shape of the device. The cylindrical pump housing 402 establishes the outermost boundary of the pump 400 and contains the internal components that facilitate aeration and circulation within a facultative lagoon.

With continued reference to FIG. 18, the bubble tube 490 is positioned concentrically within the interior of the pump 400 and extends vertically through the central portion of the assembly. The bubble tube 490 provides a pathway through which large bubbles are released to force water in an upward direction during operation. The internal cavity structure visible in the cross-section accommodates the formation of large bubbles within the pump cavity until the forces of the water release each consecutive large bubble through the top opening of the bubble tube 490.

As further shown in FIG. 18, the cross-sectional view shows dimensional annotations indicating various measurements of the pump 400 components. The spatial relationships between the cylindrical pump housing 402 and the bubble tube 490 define the pump cavity where compressed air accumulates and forms large bubbles. The concentric arrangement positions the bubble tube 490 centrally within the cylindrical pump housing 402, with the annular space between the bubble tube 490 and the cylindrical pump housing 402 accommodating the diffuser coil and water flow pathways.

The pump 400 operates with low power consumption. For depths under 10 feet, the pump 400 is operated on a 210 W linear compressor at approximately $294 per year at $0.16 per kWh running continuously 24 hours per day, 7 days per week. The low power consumption results from the pneumatic operation of the pump 400, where compressed air delivered from a shore-mounted compressor drives the bubble formation and water circulation processes without requiring submerged electrical motors or mechanical pumping mechanisms.

The pump 400 has a 20-year warranty on the unit due to HDPE construction with no moving parts. The HDPE material provides resistance to degradation from wastewater environments and maintains structural integrity over extended periods of submersion. The absence of moving parts eliminates mechanical wear, seal failures, and impeller degradation that reduce the operational lifespan of conventional pumping equipment. The combination of durable HDPE construction and the absence of moving parts provides long-term reliability without the maintenance requirements associated with mechanical aeration systems.

The pump 400 creates a pulsating surface dome approximately 10 inches high and 2 feet in diameter, displacing approximately 160 pounds of water per pulse. The pulsating surface dome forms at the surface of the facultative lagoon where large bubbles exiting the bubble tube 490 break through the water surface. Each pulse of the surface dome pushes water outward in all directions across the surface layer, generating radial ripples that propagate horizontally across the lagoon. The 160 pounds of water displaced per pulse contributes to the circulation pattern that distributes oxygenated water across the lagoon surface and creates the ripple field that provides algae control, light diffusion, and insect breeding prevention across the entire lagoon surface.

Referring to FIG. 19, the ripple pattern diagram 499 depicts a three-pump system configuration in a facultative lagoon. The ripple pattern diagram 499 illustrates a rectangular lagoon with three circulation pumps positioned within the lagoon, with each pump generating concentric ripple patterns that radiate outward across the water surface. The concentric ripple patterns from the three pumps overlap and interact, creating a combined wave field that covers the entire lagoon surface. Plants are positioned along one edge of the lagoon, and compressors are located at one corner of the lagoon to provide the air supply to the three pumps through weighted airlines. A discharge pipe is positioned at the bottom edge of the lagoon to allow treated effluent to exit the facultative lagoon system.

With continued reference to FIG. 19, when the large bubbles push water through the aerobic surface layer, a pulsating mound forms at each pump location. The pulsating mound pushes water outwards in all directions across the surface layer, generating the concentric ripple patterns that radiate from each pump position. The pulsating mounds form continuously as consecutive large bubbles exit the bubble tube 490 of each pump 400 and break through the surface of body of water 318. The water displaced by each pulsating mound flows horizontally across the surface layer until the water encounters ripples from adjacent pumps or reaches the edges of the lagoon.

As further shown in FIG. 19, the ripples generated by the three pumps are about the size of those made by a 10-mph wind blowing across open water. The ripple size provides sufficient surface agitation to promote gas exchange while avoiding excessive turbulence that would disturb the stratified layers within the facultative lagoon. The ripples expand as water moves across the surface away from each pump location, with the ripple amplitude decreasing as the distance from the pump increases until the ripples encounter ripples from adjacent pumps or reach the lagoon boundaries.

With continued reference to FIG. 19, the ripples create openings across the entire surface that allow movement of oxygen and other off gases between the water and the atmosphere. The surface agitation generated by the overlapping ripple patterns increases the air-water interface area and promotes gas exchange across the entire lagoon surface rather than at localized points. The atmospheric oxygen 317 enters the water through the openings created by the ripples, while gases generated by biological processes within the lagoon exit through the same openings. The continuous ripple field maintains gas exchange across the entire lagoon surface throughout the day and night.

As further shown in FIG. 19, the pumps are located closer to the effluent weir to form a zone that is more thoroughly mixed than the ripples flowing out into the lagoon. The positioning of the pumps near the discharge pipe creates a region of enhanced mixing adjacent to the effluent discharge point. The thoroughly mixed zone near the effluent weir results in less algae and suspended solids, slightly higher temperature, lower pH, higher levels of dissolved oxygen, and the bacteria required for denitrification of ammonia. The ripples flowing from the pump locations toward the far side of the lagoon create additional mixing and oxygen exposure time for the wastewater before the wastewater reaches the discharge pipe.

With continued reference to FIG. 19, the pump 400 creates ripples over the entire lagoon that diffuse the light required by the algae for photosynthesis. The overlapping ripple patterns from the three pumps scatter and diffuse sunlight penetration into the water column across the entire lagoon surface. The diffusion of light reduces the photosynthetically active radiation available to algae at depth, limiting algae growth throughout the lagoon. The diffusing of light also keeps the lagoon cooler because the light does not penetrate beyond the surface layer.

As further shown in FIG. 19, the ripples from the pump 400 create a surface counterflow to the lagoon's natural flow which creates a more even plug flow through the entire lagoon. The natural flow within the facultative lagoon moves from the inlet toward the discharge pipe at the bottom edge of the lagoon. The ripples generated by the three pumps create surface currents that flow outward from each pump location in all directions, including directions that oppose the natural inlet-to-outlet flow. The counterflow created by the ripples prevents short-circuiting through the lagoon from the entrance to the discharge pipe, increasing residence time and improving treatment efficiency. The lighter algae and floating plants stay along the edges of the lagoon due to the counterflow patterns rather than accumulating across the lagoon surface.

With continued reference to FIG. 19, the submerged pump 400 keeps water areas that do not experience a long hard freeze from icing over. The continuous circulation of water from the bottom of the lagoon to the surface brings non-frozen aerobic water to the surface. The ripples generated by the three pumps create surface movement that prevents ice formation across a large area of the lagoon. The ice prevention function maintains treatment capacity through winter by keeping the aerobic surface layer accessible for gas exchange with the atmosphere.

As further shown in FIG. 19, the pump 400 is designed for multi-pump system deployment with multiple pumps positioned to create overlapping ripple patterns that cover entire lagoon surfaces. The three-pump configuration depicted in the ripple pattern diagram 499 demonstrates the deployment strategy where pumps are spaced to ensure that the concentric ripple patterns from each pump overlap with the ripple patterns from adjacent pumps. The overlapping ripple patterns eliminate stagnant zones within the lagoon and provide comprehensive surface coverage for gas exchange, light diffusion, algae control, and insect breeding prevention. The multi-pump deployment allows the circulation and aeration benefits of the pump 400 to scale with lagoon size by adding additional pumps positioned to maintain overlapping ripple coverage across the entire lagoon surface.

The system can further be described as shown in FIG. 1-FIG. 19. Referring to FIG. 1 which depicts the body of water 315, the bottom of body of water 316, the atmospheric oxygen 317, the surface of body of water 318, the epilimnion 602, the living plants 604, the fish 606, the hypolimnion 608, the decaying organic material 610, the thermocline 612, the wind 614, and the circulation 616.

FIG. 2 depicts the body of water 315, the bottom of body of water 316, the compressor station 702, the weighted air line 704, the fine bubble diffuser 706, and the bubble column 708.

FIG. 3 depicts the bottom of body of water 316, the atmospheric oxygen 317, the surface of body of water 318, the compressor station 702, the weighted air line 704, the fine bubble diffuser 706, and the bubble column 708.

FIG. 4 depicts the bottom of body of water 316, the surface of body of water 318, the thermocline 612, the weighted air line 704, the fine bubble diffuser 706, the bubble column 708, the bubble zone 1 804, the bubble zone 2 806, and the bubble zone 3 808.

FIG. 5 depicts the big bubble circulator 100, the first vertical tube 102, the second vertical tube hole 107, the upper end plate 110, the flood holes 114, the main air inlet 116a, the eyebolt 126, and the eyebolt 128.

FIG. 6 depicts the first vertical tube 102, the second vertical tube hole 107, the upper end plate 110, the main air inlet 116a, the eyebolt 126, the eyebolt 128, the ballast 104, the second vertical tube 106, the air inlet 116b, the air inlet 116c, and the lower portion 133.

FIG. 7 depicts the big bubble circulator 100, the first vertical tube 102, the second vertical tube hole 107, the upper end plate 110, the flood holes 114, the main air inlet 116a, the eyebolt 126, the ballast 104, the second vertical tube 106, the expansion chamber 108, the opening 118, the third vertical tube 119, the lower flat radial edge 121, the hole 122, the upper sharp beveled radial edge 124, the second chamber 131, the main chamber 132, and the flooded reservoir 206.

FIG. 8 depicts the expansion chamber height L2, the tube length above ballast L3, the second vertical tube length L4, the opening height L5, the second vertical tube interior length L6, the ballast depth L7, and the flood hole position L8.

FIG. 9 depicts the body of water 315, the bottom of body of water 316, the surface of body of water 318, the big bubble circulator 100, the super bubble 202, the mound of water 302, the upper cover 304, the oxygenated water 308, the vertical circulation zone 312, and the dimension 320.

FIG. 10 depicts the big bubble circulator 100, the super bubble 202, the drafted water 204, and the water being lifted 205.

FIG. 11 depicts the first vertical tube 102, the second vertical tube hole 107, the upper end plate 110, the flood holes 114, the ballast 104, the air inlet 116b, the air inlet 116c, the expansion chamber 108, the opening 118, the lower flat radial edge 121, the hole 122, the upper sharp beveled radial edge 124, the second chamber 131, the flooded reservoir 206, the super bubble 202, the drafted water 204, the water being lifted 205, the first bubble 105, the lower endplate 112, the second air bubble 202a, and the third vertical tube cavity 207.

FIG. 12 depicts the bottom of body of water 316, the atmospheric oxygen 317, the surface of body of water 318, the thermocline 612, the compressor station 702, the weighted air line 704, the fine bubble diffuser 706, the big bubble circulator 100, the oxygenated water 308, the vertical circulation zone 312, and the diffuser 502.

FIG. 13 depicts the facultative lagoon diagram 399. The sun 902 produces sun energy 901 which penetrates the lagoon or pond 903. The upper layer of the lagoon or pond 903 exposed to the sun energy 901 is the aerobic zone 915 where the anerobic bacteria 920 utilizes nutrients in the upper layer or aerobic zone 915 of the lagoon or pond 903 and dissolved O₂ 925. The dissolved O₂ 925 enters the pond from the surface agitation 910 produced by the wind 905. The aerobic bacteria 920 produces CO₂ 931 and the algae 930 in the upper layer of the lagoon or pond 903 also produces the O₂ 925. The incorporation of a pump 400 creates surface agitation 910 which increases the amount of dissolved O₂ 925 in the water of the lagoon or pond 903.

The next layer is the Facultative Zone 935 of the upper layer of the lagoon or pond 903. This layer will receive some sunlight in the form of sun energy 901 and some dissolved O₂ 925. This layer has the facultative bacteria 940. The lowest layer in the upper layer of the lagoon or pond 903 is the Anerobic zone 945 which does not receive any sun light in the form of sun energy 901 and does not have any dissolved O₂ 925. This layer is home to anerobic bacteria 960 which uses nutrients found in the water and the bottom of the lagoon 961 of the lagoon or pond 903. The anerobic bacteria 960 produces gases 955 such as methane.

FIG. 14 depicts the pump 400. The pump 400 sits in the sludge of the bottom of the lagoon 961 in the anerobic zone 945. The water enters the pump 400 using holes 406. The air enters the pump 400 through the air line 407. The pump mixing zone 406 is where the water and air are mixed to create the bubbles 408 The bubbles 408 move from the pump 400 to the surface of the lagoon or pond 903 where they create ripples in the lagoon or pond 903.

FIG. 15 depicts the pump 400, the cylindrical pump housing 402, the first air inlet 410, the second air inlet 420, the air conduit 430, the diffuser coil 440, the pump cylinder 450, the concrete cavity 460, the vertical slots 470, the lower openings 480, the bubble tube 490, the sludge layer 500, and the light sludge layer 510.

FIG. 16 depicts the pump 400, the cylindrical pump housing 402, the first air inlet 410, the second air inlet 420, the air conduit 430, the diffuser coil 440, the pump cylinder 450, the bubble tube 490, the upper cover 455, and the center opening 457.

FIG. 17 depicts the cylindrical pump housing 402, the first air inlet 410, the second air inlet 420, the air conduit 430, the diffuser coil 440, the concrete cavity 460, the bubble tube 490, the short bottom tube 406, and the second flow 408.

FIG. 18 depicts the pump 400, the cylindrical pump housing 402, and the bubble tube 490.

FIG. 19 depicts the ripple pattern diagram 499.

The benefits of using the system include:
a. Multi-acre horizontal surface circulation from a single unit—something no bottom diffuser or surface aerator achieves
b. Draws cold, oxygen-depleted bottom water to the surface where it absorbs atmospheric oxygen across a wide area (not just at the bubble column)
c. Zero in-water electricity—eliminates the risk of Electric Shock Drowning (ESD), which is driving municipal bans on in-water electrical devices
d. Preserves natural thermal stratification while still circulating bottom water—unlike full-lake destratification systems that collapse the thermocline
e. Complements existing bottom-diffuser systems rather than replacing them—diffusers handle vertical mixing and dissolved oxygen saturation, the BBCP adds the horizontal surface sweep they cannot provide
f. Continuous ripple field clears algae, debris, and floating vegetation from dock and marina areas
g. Winter operation prevents ice formation around docks and pilings, protecting infrastructure
h. Storm turnover prevention—persistent radial ripples counteract wind-driven horizontal displacement of warm surface water that can collapse stratification
i. Near-zero maintenance—no motor seals, no impellers, no clogging, no underwater electrical connections to inspect
j. Low operating cost—under 10 ft depth can be operated on a 210 W linear compressor, roughly $294/year at $0.16/kWh running 24/7
k. Evaporation and surface heating reduction—ripple field scatters solar radiation across a wider surface area, reducing localized heat absorption and slowing evaporative loss
l. Algae growth suppression via light management—surface ripples scatter and diffuse sunlight penetration into the water column, reducing photosynthetically active radiation available to algae at depth
m. Fish kill prevention—continuous circulation maintains dissolved oxygen levels year-round, preventing the oxygen crashes that cause seasonal fish kills
n. Bottom nutrient mobilization—lifts nutrients from the anaerobic bottom layer into the productive upper water column where they support beneficial biological activity rather than fueling sediment accumulation
o. Accelerated organic sediment decomposition—oxygenated bottom water promotes aerobic breakdown of accumulated muck and organic material, improving water clarity and usable depth over time
p. Wildlife and habitat safety—no electrical fields, no mechanical blades, no chemical inputs; compatible with sensitive aquatic ecosystems
q. Recreational safety and compatibility—no surface hazards, no electrical risk to swimmers, no interference with boats or fishing
r. Silent, low-profile operation—no motor noise or visible surface equipment; maintains the aesthetic quality of residential, resort, and golf course water features.

The system can be used in a numerous applications including but not limited to:
a. Private pond and lake aeration and circulation
b. Dock and marina water clearing (algae, debris, floating vegetation)
c. Golf course pond management
d. HOA and community pond maintenance
e. Winter dock and piling de-icing/ice prevention
f. Resort and recreational property water quality
g. Piggyback enhancer for existing bottom-diffuser aeration systems (adds horizontal surface circulation to systems that only provide vertical mixing)
h. Shallow water body aeration where in-water electricity is a safety concern
i. Storm turnover prevention in stratified lakes
j. Evaporation reduction and surface temperature management—continuous ripple field scatters and reflects incoming solar radiation, reducing heat absorption at the water surface, lowering surface water temperature, and reducing evaporation rate; significant potential value in hot-climate and water-scarce regions
k. Solar radiation management for algae prevention—ripple field diffuses photosynthetically active radiation (PAR) entering the water column, reducing the light availability that drives algae and cyanobacterial growth; applies to any pond or lake, not just wastewater lagoons
l. Fish kill prevention—maintains dissolved oxygen levels through continuous bottom-to-surface circulation, preventing seasonal fish kills caused by oxygen depletion during summer stratification, winter ice cover, or storm-induced turnover events
m. Nutrient redistribution—transports nutrients trapped in the oxygen-depleted bottom layer up to the epilimnion where they can be utilized by beneficial plants and aquatic life rather than accumulating as sediment
n. Organic sediment and muck reduction—oxygenating bottom water accelerates aerobic decomposition of organic material on the lakebed, reducing muck accumulation over time and improving water clarity and depth
o. Aquaculture and fish farming pond management
p. Irrigation pond maintenance
q. Livestock watering pond management
r. Stormwater retention pond circulation
s. Fire suppression pond maintenance
t. Industrial cooling pond circulation
u. Reservoir water quality management
v. Municipal facultative lagoon wastewater treatment
w. EPA-permitted lagoon facilities (4,657 facilities in the U.S.)
x. Small community wastewater treatment systems
y. Industrial wastewater lagoons
z. Any facultative lagoon system facing compliance issues with effluent quality

The key features of the system include:
a. Pneumatic operation—compressed air delivered from a shore-mounted compressor through standard weighted airline; no electrical components or moving parts in the water
b. Generates consecutive large bubbles (4-5 inches in diameter) that rise as a coherent column and displace water upward via a piston effect
c. Creates a pulsating surface dome (~10 inches high, ~2 feet diameter, ~160 lbs. of water per pulse) that collapses into radial surface waves
d. Radial ripple field propagates horizontally across multiple acres, guided by the thermal density layering (thermocline) of the water body
e. Uses the same air infrastructure (compressors, airlines) as traditional bottom-diffuser systems—can be attached to the existing manifolds with zero new infrastructure
f. Constructed from HDPE with no moving parts—20-year warranty on the unit
g. Scalable design—proportions remain constant across different unit sizes
h. Simple installation—sinks to the bottom under its own ballast weight, connected by a single airline
i. Silent operation—no motor noise; suitable for residential, resort, golf course, and other noise-sensitive environments
j. No exposed moving parts in the water—no spinning blades, impellers, or propellers; safe for fish, turtles, waterfowl, and other aquatic wildlife
k. Fully submerged with no surface obstruction—compatible with recreational use (swimming, boating, fishing) with no electrical hazard, no wake from mechanical equipment, and no visible hardware beyond the ripple pattern

The assembly of all the items into a kit makes the installation simple and easy for the user because the parts necessary to install an aeration system for a lagoon or pond are provided to ensure rapid deployment and use. The kit could contain at least a pump 400, compressor station 702 and weighted air line 704.

The system can further be described as a pump for aerating and circulating water in a facultative lagoon, comprising:
a. a cylindrical pump housing including a housing wall;
b. a pump cylinder aligned concentrically with the cylindrical pump housing, the pump cylinder including an outer surface and an inner surface, a pump cavity contained in the pump cylinder, an upper cover having a center opening, and a plurality of lower openings extending through a lower portion of the pump cylinder;
c. a bubble tube aligned concentrically inside the pump cylinder whereby the center opening of the upper cover aligns with the bubble tube, wherein the bubble tube is shorter than the pump cylinder;
d. a diffuser coil extending spirally adjacent the outer surface of the pump cylinder;
e. a first air inlet for attachment to a first air supply, the first air inlet connected to the diffuser coil;
f. a second air inlet for attachment to a second air supply;
g. an air conduit having a first end attached to the second air inlet and a second end terminating in the pump cavity;
h. a concrete cavity disposed below the pump cylinder; and
i. a plurality of vertical slots extending along an upper perimeter of the cylindrical pump housing;
j. wherein the first air supply forces a first flow of air through the diffuser coil where the first flow of air mixes with water, wherein the second air supply forces a second flow of air through the air conduit and into the pump cavity, wherein large bubbles are formed in the pump cavity until forces of the water release each consecutive large bubble through a top opening of the bubble tube, and wherein the large bubbles force the water in an upward direction.

The pump of the current disclosure, wherein the cylindrical pump housing and the pump cylinder are constructed from high-density polyethylene.

The pump of the current disclosure, wherein the pump weighs approximately 180 pounds including concrete disposed within the concrete cavity.

The pump of the current disclosure, wherein the diffuser coil comprises a soaker hose configured to generate micro-bubbles that dissolve into the water within a mixing zone of the pump.

The pump of the current disclosure, wherein the micro-bubbles generated by the diffuser coil oxygenate the water before the water is lifted to a surface of the facultative lagoon by the large bubbles rising through the bubble tube.

The pump of the current disclosure, further comprising a short bottom tube positioned axially below the bubble tube to facilitate formation of the large bubbles.

The pump of the current disclosure, wherein the large bubbles have a diameter of approximately 4 to 5 inches.

The pump of the current disclosure, wherein the large bubbles create a pulsating surface dome at a surface of the facultative lagoon, the pulsating surface dome having a height of approximately 10 inches and a diameter of approximately 2 feet.

The pump of the current disclosure, wherein the upper cover prevents air from exiting the pump cavity at an upper cavity portion and directs air flow through the center opening.

The pump of the current disclosure, wherein the vertical slots provide water intake from an aerobic zone of the facultative lagoon into an interior of the pump.

The pump of the current disclosure, wherein the pump is configured to operate at a minimum water depth of 30 inches.

A method of the current disclosure for aerating and circulating water in a facultative lagoon using a pump positioned in the facultative lagoon, the method comprising:
a. supplying a first flow of compressed air through a first air inlet to a diffuser coil that extends spirally adjacent an outer surface of a pump cylinder, wherein the first flow of compressed air generates micro-bubbles that dissolve into water flowing through the pump;
b. supplying a second flow of compressed air through a second air inlet and an air conduit into a pump cavity contained within the pump cylinder;
c. forming large bubbles in the pump cavity from the second flow of compressed air;
d. releasing consecutive large bubbles through a bubble tube aligned concentrically inside the pump cylinder; and
e. forcing water in an upward direction through the bubble tube toward a surface of the facultative lagoon, wherein the large bubbles rising through the bubble tube create a circulation pattern that draws water from an aerobic zone of the facultative lagoon through a plurality of lower openings in the pump cylinder and lifts the water to the surface.

The method of the current disclosure, wherein the micro-bubbles dissolve into the water within a mixing zone of the pump to oxygenate the water before the water is lifted to the surface by the large bubbles.

The method of the current disclosure, wherein the large bubbles have a diameter of approximately 4 to 5 inches and create a pulsating surface dome at the surface of the facultative lagoon.

The method of the current disclosure, wherein the pulsating surface dome collapses into radial surface waves that propagate horizontally across the facultative lagoon, creating ripples that diffuse light penetration into a water column of the facultative lagoon.

The method of the current disclosure, wherein the circulation pattern draws water through a plurality of vertical slots extending along an upper perimeter of a cylindrical pump housing that surrounds the pump cylinder, and wherein the water drawn through the vertical slots flows downward into the pump and through the plurality of lower openings into the pump cavity.

A system of the current disclosure for aerating and circulating water in a facultative lagoon, comprising:
a. a compressor station positioned on shore;
b. at least one pump positioned in the facultative lagoon, the at least one pump including:
c. a cylindrical pump housing having a plurality of vertical slots extending along an upper perimeter;
d. a pump cylinder aligned concentrically within the cylindrical pump housing, the pump cylinder having a pump cavity, an upper cover with a center opening, and a plurality of lower openings;
e. a bubble tube aligned concentrically inside the pump cylinder and shorter than the pump cylinder;
f. a diffuser coil extending spirally adjacent an outer surface of the pump cylinder;
g. a first air inlet connected to the diffuser coil;
h. a second air inlet;
i. an air conduit extending from the second air inlet into the pump cavity; and
j. a concrete cavity disposed below the pump cylinder; and
k. at least one weighted air line connecting the compressor station to the at least one pump;
l. wherein the compressor station supplies compressed air through the at least one weighted airline to the first air inlet and the second air inlet, wherein compressed air supplied to the first air inlet flows through the diffuser coil to generate micro-bubbles that oxygenate water within the pump, and wherein compressed air supplied to the second air inlet flows through the air conduit to form large bubbles in the pump cavity that rise through the bubble tube and force water upward to create surface ripples across the facultative lagoon.

The system of the current disclosure, wherein the at least one pump comprises a plurality of pumps positioned within the facultative lagoon to create overlapping ripple patterns that cover an entire surface of the facultative lagoon.

The system of the current disclosure, wherein the plurality of pumps are positioned closer to an effluent weir of the facultative lagoon to form a thoroughly mixed zone adjacent to the effluent weir.

The system of the current disclosure, wherein the at least one pump is constructed from high-density polyethylene and contains no moving parts, and wherein the concrete cavity holds concrete that provides ballast to stabilize the at least one pump in a sludge layer of the facultative lagoon.

Referring now to the drawings FIG. 1-19 , and more particularly to FIG. 1, there is shown a body of water 315, the bottom of body of water 316, the atmospheric oxygen 317, the surface of body of water 318, the epilimnion 602, the living plants 604, the fish 606, the hypolimnion 608, the decaying organic material 610, the thermocline 612, the wind 614, and the circulation 616.

FIG. 2 depicts the body of water 315, the bottom of body of water 316, the compressor station 702, the weighted air line 704, the fine bubble diffuser 706, and the bubble column 708.

FIG. 3 depicts the bottom of body of water 316, the atmospheric oxygen 317, the surface of body of water 318, the compressor station 702, the weighted air line 704, the fine bubble diffuser 706, and the bubble column 708.

FIG. 4 depicts the bottom of body of water 316, the surface of body of water 318, the thermocline 612, the weighted air line 704, the fine bubble diffuser 706, the bubble column 708, the bubble zone 1 804, the bubble zone 2 806, and the bubble zone 3 808.

FIG. 5 depicts the big bubble circulator 100, the first vertical tube 102, the second vertical tube hole 107, the upper end plate 110, the flood holes 114, the main air inlet 116a, the eyebolt 126, and the eyebolt 128.

FIG. 6 depicts the first vertical tube 102, the second vertical tube hole 107, the upper end plate 110, the main air inlet 116a, the eyebolt 126, the eyebolt 128, the ballast 104, the second vertical tube 106, the air inlet 116b, the air inlet 116c, and the lower portion 133.

FIG. 7 depicts the big bubble circulator 100, the first vertical tube 102, the second vertical tube hole 107, the upper end plate 110, the flood holes 114, the main air inlet 116a, the eyebolt 126, the ballast 104, the second vertical tube 106, the expansion chamber 108, the opening 118, the third vertical tube 119, the lower flat radial edge 121, the hole 122, the upper sharp beveled radial edge 124, the second chamber 131, the main chamber 132, and the flooded reservoir 206.

FIG. 8 depicts the expansion chamber height L2, the tube length above ballast L3, the second vertical tube length L4, the opening height L5, the second vertical tube interior length L6, the ballast depth L7, and the flood hole position L8.

FIG. 9 depicts the body of water 315, the bottom of body of water 316, the surface of body of water 318, the big bubble circulator 100, the super bubble 202, the mound of water 302, the upper cover 304, the oxygenated water 308, the vertical circulation zone 312, and the dimension 320.

FIG. 10 depicts the big bubble circulator 100, the super bubble 202, the drafted water 204, and the water being lifted 205.

FIG. 11 depicts the first vertical tube 102, the second vertical tube hole 107, the upper end plate 110, the flood holes 114, the ballast 104, the air inlet 116b, the air inlet 116c, the expansion chamber 108, the opening 118, the lower flat radial edge 121, the hole 122, the upper sharp beveled radial edge 124, the second chamber 131, the flooded reservoir 206, the super bubble 202, the drafted water 204, the water being lifted 205, the first bubble 105, the lower endplate 112, the second air bubble 202a, and the third vertical tube cavity 207.

FIG. 12 depicts the bottom of body of water 316, the atmospheric oxygen 317, the surface of body of water 318, the thermocline 612, the compressor station 702, the weighted air line 704, the fine bubble diffuser 706, the big bubble circulator 100, the oxygenated water 308, the vertical circulation zone 312, and the diffuser 502.

FIG. 13 depicts the facultative lagoon diagram 399.

FIG. 14 depicts the pump 400.

FIG. 15 depicts the pump 400, the cylindrical pump housing 402, the first air inlet 410, the second air inlet 420, the air conduit 430, the diffuser coil 440, the pump cylinder 450, the concrete cavity 460, the vertical slots 470, the lower openings 480, the bubble tube 490, the sludge layer 500, and the light sludge layer 510.

FIG. 16 depicts the pump 400, the cylindrical pump housing 402, the first air inlet 410, the second air inlet 420, the air conduit 430, the diffuser coil 440, the pump cylinder 450, the bubble tube 490, the upper cover 455, and the center opening 457.

FIG. 17 depicts the cylindrical pump housing 402, the first air inlet 410, the second air inlet 420, the air conduit 430, the diffuser coil 440, the concrete cavity 460, the bubble tube 490, the short bottom tube 406, and the second flow 408.

FIG. 18 depicts the pump 400, the cylindrical pump housing 402, and the bubble tube 490.

FIG. 19 depicts the ripple pattern diagram 499.

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments; it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

I claim

1. A pump for aerating and circulating water in a pond, comprising:
a cylindrical pump housing including a housing wall;
a pump cylinder aligned concentrically with the cylindrical pump housing, the pump cylinder including an outer surface and an inner surface, a pump cavity contained in the pump cylinder, an upper cover having a center opening, and a plurality of lower openings extending through a lower portion of the pump cylinder;
a bubble tube aligned concentrically inside the pump cylinder whereby the center opening of the upper cover aligns with the bubble tube, wherein the bubble tube is shorter than the pump cylinder;
a diffuser coil extending spirally adjacent the outer surface of the pump cylinder;
a first air inlet for attachment to a first air supply, the first air inlet connected to the diffuser coil;
a second air inlet for attachment to a second air supply;
an air conduit having a first end attached to the second air inlet and a second end terminating in the pump cavity;
a concrete cavity disposed below the pump cylinder; and
a plurality of vertical slots extending along an upper perimeter of the cylindrical pump housing;
wherein the first air supply forces a first flow of air through the diffuser coil where the first flow of air mixes with water, wherein the second air supply forces a second flow of air through the air conduit and into the pump cavity, wherein large bubbles are formed in the pump cavity until forces of the water release each consecutive large bubble through a top opening of the bubble tube, and wherein the large bubbles force the water in an upward direction and large bubbles have a diameter of approximately 4 to 5 inches and create a pulsating surface dome at the surface of the pond and the pulsating surface dome collapses into radial surface waves that propagate horizontally across the pond, creating ripples that diffuse light penetration into a water column of the pond.

2. The pump of claim 1, wherein the cylindrical pump housing and the pump cylinder are constructed from high-density polyethylene.

3. The pump of claim 2, wherein the pump weighs approximately 180 pounds including concrete disposed within the concrete cavity.

4. The pump of claim 1, wherein the diffuser coil comprises a soaker hose configured to generate micro-bubbles that dissolve into the water within a mixing zone of the pump.

5. The pump of claim 4, wherein the micro-bubbles generated by the diffuser coil oxygenate the water before the water is lifted to a surface of the facultative lagoon by the large bubbles rising through the bubble tube.

6. The pump of claim 1, further comprising a short bottom tube positioned axially below the bubble tube to facilitate formation of the large bubbles.

7. The pump of claim 1, wherein the large bubbles have a diameter of approximately 4 to 5 inches.

8. The pump of claim 7, wherein the large bubbles create a pulsating surface dome at a surface of the facultative lagoon, the pulsating surface dome having a height of approximately 10 inches and a diameter of approximately 2 feet.

9. The pump of claim 1, wherein the upper cover prevents air from exiting the pump cavity at an upper cavity portion and directs air flow through the center opening.

10. The pump of claim 1, wherein the vertical slots provide water intake from an aerobic zone of the facultative lagoon into an interior of the pump.

11. The pump of claim 1, wherein the pump is configured to operate at a minimum water depth of 30 inches.

12. A method for aerating and circulating water in a facultative lagoon using a pump positioned in the facultative lagoon, the method comprising:
supplying a first flow of compressed air through a first air inlet to a diffuser coil that extends spirally adjacent an outer surface of a pump cylinder, wherein the first flow of compressed air generates micro-bubbles that dissolve into water flowing through the pump;
supplying a second flow of compressed air through a second air inlet and an air conduit into a pump cavity contained within the pump cylinder;
forming large bubbles in the pump cavity from the second flow of compressed air;
releasing consecutive large bubbles through a bubble tube aligned concentrically inside the pump cylinder; and
forcing water in an upward direction through the bubble tube toward a surface of the facultative lagoon, wherein the large bubbles rising through the bubble tube create a circulation pattern that draws water from an aerobic zone of the facultative lagoon through a plurality of lower openings in the pump cylinder and lifts the water to the surface.

13. The method of claim 12, wherein the micro-bubbles dissolve into the water within a mixing zone of the pump to oxygenate the water before the water is lifted to the surface by the large bubbles.

14. The method of claim 12, wherein the large bubbles have a diameter of approximately 4 to 5 inches and create a pulsating surface dome at the surface of the facultative lagoon.

15. The method of claim 14, wherein the pulsating surface dome collapses into radial surface waves that propagate horizontally across the facultative lagoon, creating ripples that diffuse light penetration into a water column of the facultative lagoon.

16. The method of claim 12, wherein the circulation pattern draws water through a plurality of vertical slots extending along an upper perimeter of a cylindrical pump housing that surrounds the pump cylinder, and wherein the water drawn through the vertical slots flows downward into the pump and through the plurality of lower openings into the pump cavity.

17. A system for aerating and circulating water in a facultative lagoon, comprising:
a compressor station positioned on shore;
at least one pump positioned in the facultative lagoon, the at least one pump including:
a cylindrical pump housing having a plurality of vertical slots extending along an upper perimeter;
a pump cylinder aligned concentrically within the cylindrical pump housing, the pump cylinder having a pump cavity, an upper cover with a center opening, and a plurality of lower openings;
a bubble tube aligned concentrically inside the pump cylinder and shorter than the pump cylinder;
a diffuser coil extending spirally adjacent an outer surface of the pump cylinder;
a first air inlet connected to the diffuser coil;
a second air inlet;
an air conduit extending from the second air inlet into the pump cavity; and
a concrete cavity disposed below the pump cylinder; and
at least one weighted air line connecting the compressor station to the at least one pump;
wherein the compressor station supplies compressed air through the at least one weighted airline to the first air inlet and the second air inlet, wherein compressed air supplied to the first air inlet flows through the diffuser coil to generate micro-bubbles that oxygenate water within the pump, and wherein compressed air supplied to the second air inlet flows through the air conduit to form large bubbles in the pump cavity that rise through the bubble tube and force water upward to create surface ripples across the facultative lagoon.

18. The system of claim 17, wherein the at least one pump comprises a plurality of pumps positioned within the facultative lagoon to create overlapping ripple patterns that cover an entire surface of the facultative lagoon.

19. The system of claim 18, wherein the plurality of pumps are positioned closer to an effluent weir of the facultative lagoon to form a thoroughly mixed zone adjacent to the effluent weir.

20. The system of claim 17, wherein the at least one pump is constructed from high-density polyethylene and contains no moving parts, and wherein the concrete cavity holds concrete that provides ballast to stabilize the at least one pump in a sludge layer of the facultative lagoon.
